(19) United States
(12) Patent Application Publication
(10) Pub. No.: US 2024/0311886 A2
(43) Pub. Date: Sep. 19, 2024

(54) USE OF A DISTRIBUTED LEDGER SYSTEM FOR MONITORING GOODS DELIVERIES

(71) Applicants: Evonik Operations GmbH, Essen (DE); BASF SE, Ludwigshafen am Rhein (DE); Commerzbank AG, Frankfurt am Main (DE)

(72) Inventors: Heinz LUX, Overath (DE); Ralf KAHRE, Neustadt an der Weinstrasse (DE); Nils GAGELMANN, Mannheim (DE); Oliver PIEPER, Rottenburg an der Neckar (DE); Sven LEHNERT, Kelkheim (DE); Patrik VOELKER, Reichelsheim (DE); Andreas JÖST, Frankfurt (DE)

(73) Assignees: Evonik Operations GmbH, Essen (DE); BASF SE, Ludwigshafen am Rhein (DE); Commerzbank AG, Frankfurt am Main (DE)

(21) Appl. No.: 18/473,120

(22) Filed: Sep. 22, 2023

(30) Foreign Application Priority Data
Sep. 23, 2022 (EP) 22197305.0

(51) Int. Cl. G06Q 30/0601; G06Q 20/10; G06Q 30/018; G06Q 30/04; H04L 9/40

(52) U.S. Cl. CPC G06Q 30/0607; G06Q 20/108; G06Q 30/018; G06Q 30/04; H04L 63/0428; H04L 63/0869

(57) ABSTRACT

The invention relates to a method for computer-implemented monitoring of a goods delivery from a seller to a buyer by using an access-restricted DLT system. The DLT system comprises a first DLT node assigned to the buyer and a second DLT node assigned to the seller. In addition, the DLT system provides at least one smart contract with program instructions for entering and checking delivery orders, order confirmations, and outgoing goods logs in the course of goods deliveries from the seller to the buyer, and for validating the goods delivery. The method comprises, for example, initialising the goods delivery in the DLT system, for example, logging the goods delivery in the DLT system and/or, for example, validating the goods delivery in the DLT system.

The invention relates to a method for computer-implemented monitoring of a goods delivery from a seller to a buyer using an access-restricted DLT system. The invention also relates to the use of a shared dataset of a DLT system in the course of a computer-implemented monitoring of the goods delivery, a DLT node of the access-restricted DLT system, which is implemented on a DLT server of the DLT system and assigned to the buyer, a DLT node of the access-restricted DLT system, which is implemented on a DLT server of the DLT system and assigned to the seller of the goods delivery, the access-restricted DLT system for computer-implemented monitoring of the goods delivery, and to a computer program for monitoring the goods delivery using the access-restricted DLT system.

Document WO 2021/18366 A1 discloses a method for adjusting a production process, wherein a first node of a first party of a blockchain network is designed to publish order transactions in the blockchain network, wherein published order transactions are validated by the blockchain network, wherein the method comprises analysing validated order transactions in the blockchain network by at least one node of a second party of the blockchain network, wherein the analysis comprises the following:
identifying validated order transactions, extracting order parameters, sending order parameters to a simulation system to simulate a production process for the ordered product based on the order parameters, receiving a capacity parameter from the simulation system, generating an offer based on the capacity parameter, and if the first vendor node accepts the offer, adjusting the production process based on the offer.

These or other approaches to tracking goods use blockchains. However, blockchains have the disadvantage that once data is entered in the blockchain it can no longer be modified. Furthermore, data entered in a blockchain is visible at least to all blockchain servers managing the corresponding blockchain. In the case of a public blockchain, the data entered in the blockchain is even publicly accessible, i.e. to anyone.

The object of the invention is to create an improved method which is suitable for monitoring a goods delivery and can guarantee the security and confidentiality of the data used in the course of said monitoring.

The problem addressed by the invention is solved with the features of the independent patent claims. Embodiments of the invention are specified in the dependent claims.

Embodiments relate to a method for computer-implemented monitoring of a goods delivery from a seller to a buyer by using an access-restricted DLT system. The DLT system comprises a first DLT node assigned to the buyer and a second DLT node assigned to the seller. In addition, the DLT system provides at least one smart contract. The at least one smart contract comprises program instructions for entering and checking delivery orders and order confirmations.

The method comprises initialising the goods delivery in the DLT system. The initialising comprises:
receiving a delivery order of the buyer via a first network by means of the first DLT node relating to goods to be delivered from the seller to the buyer, wherein the delivery order defines one or more physical properties of the goods to be delivered as a first specification, the physical properties of the first specification comprising at least one quantity of goods to be delivered,
creating a first dataset managed by the first DLT node and entering at least the one or more physical properties of the delivery order into the first dataset by means of the first DLT node by using the at least one smart contract, wherein the first dataset is a first part of a dataset shared between the first DLT node and the second DLT node,
transferring at least the first dataset from the first DLT node to the second DLT node,
creating a second dataset managed by the second DLT node, wherein the second dataset is a second part of the shared dataset, and performing a first update of the second dataset by means of the second DLT node based on the first dataset, wherein the first update comprises entering at least one or more of the physical properties of the first specification into the second dataset, the at least one or more entered physical properties of the first specification comprising the quantity of goods to be delivered,
receiving an order confirmation of the seller via the first network by means of the second DLT node, wherein the order confirmation comprises a second specification of the one or more physical properties of the goods to be delivered,
checking the second specification for consistency with the first specification by using the at least one smart contract,
performing a second update of the second dataset by means of the second DLT node by using a first result of the check of the second specification,
transferring at least a first update message from the second DLT node to the first DLT node,
performing a first update of the first dataset by means of the first DLT node by using the first update message.

Embodiments include a method, which further comprises a logging of the goods delivery in the DLT system. The at least one smart contract comprises program instructions for entering and checking outgoing goods logs in the course of goods deliveries from the seller to the buyer. The logging comprises:
receiving an outgoing goods log from the seller via the first network by means of the second DLT node, wherein the outgoing goods log comprises one or more first sensor values for the one or more physical properties of the outgoing goods according to the second specification, which are detected by means of one or more first physical sensors assigned to the seller, the one or more first sensor values comprising at least one first sensor value which quantifies the delivered quantity of goods,
checking the one or more first sensor values of the outgoing goods log for consistency with the one or more physical properties of the goods to be delivered according to the shared dataset within predefined first tolerances by using the at least one smart contract, wherein the checked first sensor values comprise at least the first sensor value quantifying the quantity of goods delivered,
performing a third update of the second dataset by means of the second DLT node by using a second result of checking the one or more first sensor values of the outgoing goods log,
transmitting at least a second update message from the second DLT node to the first DLT node,
performing a second update of the first dataset by means of the first DLT node by using the second update message.

Embodiments include a method, which further comprises validating the goods delivery in the DLT system. The at least one smart contract contains program instructions for validating the goods delivery. The validation comprises:
checking parameters of a validation message for validating the goods delivery by means of the second DLT node by using the at least one smart contract, wherein the parameters comprise at least one quantity of goods to be validated, the parameter checking comprising checking the quantity of goods to be validated for consistency with the first sensor value quantifying the quantity of goods delivered within a predefined second tolerance,
if the quantity of goods to be validated is consistent with the first sensor value quantifying the quantity of goods delivered within the predefined second tolerance, performing a fourth update of the second dataset by means of the second DLT node, wherein the fourth update comprises registering the validation message in the second dataset by means of the second DLT node using the at least one smart contract,
transmitting at least a third update message from the second DLT node to the first DLT node,
performing a third update of the first dataset by means of the first DLT node by using the third update message, wherein the third update of the first dataset comprises registering the validation message in the first dataset.

In the course of initialising the goods delivery, a shared dataset is generated on two DLT nodes of an access-restricted DLT system. This shared dataset is a dataset that comprises a first partial dataset on the first DLT node and a second partial dataset on the second DLT node. Only the first DLT node (or another DLT node authorised for this purpose) and thus the buyer can have authorisation to edit the first partial dataset, i.e. write authorisation, whereas for the second dataset only the second DLT node (or another DLT node authorised for this purpose) and thus the seller can have editing authorisation, i.e. a write authorisation. In addition, as a result of the access restriction of the DLT system, for example, only the buyer via the first DLT node (or the further authorised DLT node) can have read authorisation for reading the first partial dataset and only the seller can have read authorisation for reading the second partial dataset via the second DLT node (or the further authorised DLT node).

The term distributed ledger technology describes a technology used for logging transactions or states of transactions. In contrast to the classical approach, in which a ledger is usually managed as a general ledger by only one entity, here any number of copies of the ledger that are in principle equally valid are maintained by different parties on a decentralised basis. For example, parties with at least one corresponding node in the DLT system may be goods sellers, goods buyers, goods manufacturers and/or goods suppliers, wherein parties may also be overlapping, such as those of the goods producer and the supplier as a single party. Furthermore, a party with at least one node may be a finance partner, savings bank, a banking institution and/or a credit institution (hereafter referred to as simply “bank”). Such node related to a bank is also named as “bank DLT node”. One bank DLT node might be a Cash Issuer Node (CIN) configured to verify and process issuance as well as redemption of digital money as means of payment in the DLT-system. Another party can be a regulator with one node in the DLT-system to fulfill specific regulatory functions such as compliance with anti-money-laundering or sanction screening requirements. At least one node may also be designated as a technical notary to confirm uniqueness of each transaction and to prevent double spending of digital based money. Herein a commissioned and authorised service partner, rendering at least partial services in the field of information technology, such as but not limited to e.g., server hosting, computer programming, software development, data storage.

Appropriate measures are taken to ensure that new transactions or states of transactions to be added are incorporated into all copies of the ledger and that an agreement (or consensus) is reached on the current status of the ledger.

For example, the at least one Smart Contract, which is implemented, for example, on both DLT nodes, is configured to ensure data consistency between the two partial datasets of the shared dataset. For example, mirrored, i.e. identical, data can be implemented in both partial datasets of the shared dataset by means of synchronous data maintenance. The technical features of this shared dataset enable a trusted data source (e.g., in combination with an ERP system-“single point of truth”) and bidirectional validation via Smart Contract run on a DLT.

The present method does not use a blockchain, but is based on direct data exchange between the DLT nodes of the parties involved and on a direct data validation by the corresponding DLT nodes. The use of an access-restricted DLT system has the advantage over a public blockchain that access to the data managed by the DLT system is restricted. For example, the DLT system subscribers can only access one DLT node that is assigned to them at a time. For example, data from the shared datasets within the DLT system is transferred only between the DLT nodes between which the dataset is shared. For example, the transmission takes place only between the first DLT node of the buyer and the second DLT node of the seller. For example, a unicast transmission is used, i.e. the transferred data is addressed in each case to a single recipient, i.e. a single DLT node. In contrast to broadcast transmission, as in the case of numerous blockchain solutions, unicast transmission has the advantage that only senders and receivers acquire knowledge of the transferred data.

Since transactions in a blockchain are usually viewable by all validating nodes, for example when transferring transactions to be entered within the blockchain network via broadcast, this approach lacks confidentiality. A blockchain typically stores data as transactions in individual blocks that are chained together and are managed redundantly in a distributed peer-to-peer network. Due to the redundant management, a large number of nodes have access to all the data stored in the blockchain. On the other hand, embodiments of the present invention have the advantage that both data security and confidentiality of the data stored in the shared dataset can be guaranteed. This is achieved by the fact that communication relating to the transactions to be mapped, i.e. the data to be stored in a shared dataset, takes place within the DLT system only between the DLT nodes involved, i.e. those DLT nodes between which the corresponding dataset is shared. For example, these are only the first DLT node of the buyer and the second DLT node of the seller. The goods delivery in this case is monitored by means of the one or more smart contracts, which are implemented on the nodes involved. No storage takes place in a blockchain or any other dataset that can be viewed by all DLT nodes.

For this purpose, a dataset that is shared by the DLT nodes involved is used, which has a first (partial) dataset that is managed by the DLT node of the buyer, and a second (partial) dataset that is managed by the DLT node of the seller. The two (partial) datasets should be identical to each other and reflect the view of the node responsible for each one. Only the responsible DLT node is authorised to modify the corresponding part of the dataset. The partial datasets, and thus the transactions stored in the corresponding partial datasets, are each transferred to the other DLT node. For example, only changes to the corresponding partial dataset are transferred to the other DLT node at a time. For example, the data transferred to the other DLT nodes is signed. The signature allows the other DLT node to verify that the changes are correct or authorised by the signing DLT node and thus by the associated subscribers.

Furthermore, it is not necessary for the first and second partial sets to be identical. For example, a partial dataset may include one or more data values that differ from those in the other partial dataset, for example with regard to the goods delivery, for example with regard to the quantity of the corresponding goods to be delivered or other factors. This may allow, for example, tolerances on which deviations are acceptable to be pre-defined. Alternatively or in addition, a semi-automatic or fully automatic handshake can take place between the two DLT nodes managing the two partial datasets until agreement has been reached on individual data values of the dataset that differ from each other, for example, the goods to be delivered and their properties, i.e. the differences have been eliminated.

In general, the quantity of goods might include and/or being represented of a defined quality of goods. Thus, “quantity of goods” shall mean “quantity and/or defined quality of goods”, due to the fact that the existence of a piece of good and traceability by a sensor is the first inherent quality of this piece of good.

Embodiments may thus have the advantage that, based on the dataset distributed over two DLT nodes and/or the further features described above for matching the (partial) datasets, an approach to the confidential handling of transactions between the two DLT nodes is provided. This approach also enables transactions to be secured and increases data security between the DLT nodes.

For example, communication between the DLT nodes takes place via transport connections secured by means of the Transport Layer Security protocol (TLS). In addition, communication with the DLT nodes takes place, for example, when the buyer accesses the first DLT node with a computer system assigned to the buyer and/or when the seller accesses the second DLT node with a computer system assigned to the seller via TLS-secured transport connections.

For example, all transport connections are secured with TLS. The security principle within the DLT system is based, for example, on peer-to-peer communication between the DLT nodes and the need-to-know principle. Peer-to-peer communication is based on computer-to-computer connection between computers with equal authorisation. The need-to-know principle, or the principle of necessity, requires as a security objective for data that access to the corresponding data requires not only basic access authorisation, but also that the data to be accessed is directly necessary for the fulfilment of a specific task. For example, even if a DLT node has access to data on a specific or a defined security layer, the need-to-know principle prohibits access if the corresponding data is not required directly to perform a specific task by that DLT node.

Each DLT node receives only the data that affects it. As a result, information cannot flow through a compromised DLT node since it is not involved in managing shared datasets of other DLT nodes, and data within the DLT system is not publicly accessible or not published.

Embodiments may have the advantage that encryption of the data in the partial datasets of the shared dataset can be dispensed with. Data can be entered and saved in the partial datasets in plain text. The need-to-know principle ensures that relevant data is only exchanged between the DLT nodes involved. This provides effective protection of sensitive information against unauthorised access. The network architecture used in the DLT system already ensures effective data security and confidentiality. No data at all is sent to other DLT nodes unless it directly affects them or the subscribers assigned to them (need-to-know principle). This is in contrast to the approach of a classical blockchain. In order to store sensitive data securely in a blockchain, this data must be entered and stored in an encrypted form. Alternatively, only results from an application of a one-way function, such as a hash function, to the corresponding data are entered and stored. As a result of the broadcast among all nodes of the system, a blockchain is typically also visible to all nodes of the system, so that sensitive information in a blockchain must be protected by additional measures. These additional measures, such as encryption or the application of a one-way function, only allow basic protection of the data and information stored in the blockchain.

If data in the partial datasets of the shared dataset is encrypted, this results in an additional increase in the level of security for the corresponding data above an existing level of basic protection which is already provided by the network architecture, and this is not used only for implementing basic protection as in the case of a classical blockchain. For example, the data in the partial datasets of the shared dataset is entered in encrypted form and/or the partial datasets are stored in encrypted form.

According to embodiments, no broadcasting takes place within the DLT system, as would be the case, for example, if a blockchain were used. For example, communication between the DLT nodes is in fact based on a unicast or a direct communication between the DLT nodes involved, for example, via a dedicated communication link.

Embodiments enable, for example, mirrored data regarding the goods transfer to be ensured on both sides, i.e. at the buyer end and the seller end, in the form of the first and the second dataset. These mirrored sets of data can also be integrated into connected enterprise resource planning (ERP) systems on both sides, for example.

The mirrored data and synchronous data maintenance thus provided is advantageous for the digital integration of, for example, ordering, delivery and financial processes between the business partners, for example, the buyer and the seller. Herein “business partner”, “buyer” and/or “seller” shall also mean a commissioned and authorised business service partner, rendering at least partial services in the field of information technology on behalf of a business partner, such as but not limited to e.g., server hosting, computer programming, software development, data storage. For example, this can ensure consistent data quality and be measurable by both parties, for example using performance indicators such as key performance indicators (KPIs). The implementation of in-process validation ensures the sustainability of data quality that has already been achieved, thus preventing gradual deterioration. By using the DLT system to provide a common location of the database in the form of shared datasets for monitoring goods deliveries, for example, the reconciliation effort required will be lower. For example, the effort required for later account reconciliation can be significantly reduced or, ideally, even completely eliminated on the part of both business partners in the long term. This can help improve data quality and process efficiency. For example, the scope of manual activities can be reduced.

Initially, for example, as a result of receiving a delivery order comprising a first specification of the goods to be delivered, one or more physical properties of the goods to be delivered are entered in the first dataset managed by the first DLT node, i.e. the first partial dataset of the shared dataset, in accordance with the first specification. These one or more entered physical properties according to the first specification include at least a quantity of goods to be delivered.

This first dataset or the one or more physical properties entered in the first dataset according to the first specification are transferred to the second DLT node of the seller. The second DLT node creates the second partial dataset of the shared dataset, into which one or more physical properties according to the first specification are entered. In this case the one or more entered physical properties according to the first specification includes at least a quantity of goods to be delivered. As a result, for example, both partial datasets of the shared dataset thus comprise identical data.

Upon receipt of an order confirmation comprising a second specification of the one or more physical properties of the goods to be delivered, the second specification is checked for consistency with the first specification by means of the second DLT node using the at least one smart contract, and the second dataset is updated using the result of the second specification check.

If the second specification is consistent with the first specification, the updating of the second dataset using the test result comprises, for example, entering a confirmation of the first specification. For example, the updating of the second dataset using the test result comprises entering the second specification into the second dataset in addition to the first specification.

If the second specification differs from the first specification, updating the second dataset using the test result comprises, for example, replacing or updating the physical properties according to the first specification with the differing physical properties according to the second specification. For example, in the course of updating the second dataset, the diverging physical properties according to the second specification are entered into the second dataset in addition to the first specification. For example, the second specification is entered into the second dataset in addition to the first specification.

In addition, a first update message is transferred from the second DLT node to the first DLT node. For example, the first update message indicates whether the second specification is consistent with the first specification. For example, if one or more physical properties according to the second specification differ from the first specification, the first update message identifies the one or more diverging physical properties according to the second specification. For example, the first update message comprises the entire second specification or a copy of the second specification.

Such a deviation of one or more physical properties according to the second specification from the first specification may occur, for example, because only a certain minimum quantity of goods is available or the goods are only delivered in specific quantity units, e.g. within the scope of a tanker wagon or a tanker truck. Such a deviation of one or more physical properties according to the second specification from the first specification may occur, for example, because the available product properties differ from the product properties ordered.

The first DLT node updates the first dataset, i.e. the first partial dataset of the shared dataset, using the first update message. If the second specification is consistent with the first specification, updating the first dataset using the first update message comprises, for example, entering a confirmation of the first specification. For example, the updating of the first dataset using the first update message comprises entering the second specification into the first dataset in addition to the first specification.

If the second specification differs from the first specification, updating the second dataset using the first update message comprises, for example, replacing or updating the physical properties according to the first specification with the differing physical properties according to the second specification. For example, in the course of updating the first dataset, the differing physical properties according to the second specification are entered into the second dataset in addition to the first specification. For example, the second specification is entered into the second dataset in addition to the first specification.

If the second specification differs from the first specification, for example, a “handshake” is performed between the first DLT node and the second DLT node to match the first specification with the second specification, so that the first and second specifications resulting from the match are identical.

A handshake refers to an automated negotiation process between two participants, in this case the two DLT nodes, by an exchange of data, in this case information on physical properties of the goods to be delivered. In this case, the handshake can be used to set the conditions of a goods delivery before the physical delivery of the goods begins. For example, using the at least one smart contract, a handshake protocol is executed between the two DLT nodes, resulting in an adjustment of one or both specifications until an identical match, i.e. identity, exists between these two specifications.

If the second specification is consistent with the first specification, for example, a confirmation message from the second DLT node is sent to the seller over the network. For example, the second specification is consistent with the first specification if the two specifications are identical, i.e. identically matched. For example, the second specification is consistent with the first specification if there are no deviations that exceed a predefined tolerance range. For example, the confirmation message indicates to the seller that an agreement has been reached on the corresponding goods delivery between buyer and seller. In addition, the confirmation message includes, for example, the specification of the corresponding goods delivery. For example, the corresponding confirmation message serves as a trigger to initiate the corresponding goods delivery.

In addition, the goods delivery is logged in the DLT system. If the physical goods delivery is carried out, i.e. the goods to be delivered leave a warehouse of the seller, an outgoing goods log is created. The corresponding outgoing goods log comprises one or more sensor values for the one or more physical properties of the outgoing goods according to the second specification, which are detected by means of one or more physical sensors assigned to the seller. The outgoing goods log therefore specifies for one or more physical properties, for which target values are specified in the second specification, measured values detected by sensors in each case, which reflect the actual status of the outgoing goods with regard to the corresponding physical properties. The corresponding sensor values include at least one sensor value which quantifies the delivered, i.e. outgoing, quantity of goods.

The second DLT node of the seller receives the outgoing goods log from the seller via the first network and checks the one or more first sensor values of the outgoing goods log for conformity with the one or more physical properties of the goods to be delivered. In this process, it is checked whether the one or more sensor values of the outgoing goods log are consistent with one or more physical properties according to the shared dataset within predefined tolerances. If no such consistency is present, for example, a warning message is sent to the seller and/or the buyer. Such a warning can, for example, trigger a re-delivery by the seller if the delivery quantity is too little. For example, such a warning message may stop the delivery process if, for example, a product property does not meet the specification. In this case, for example, either the buyer must agree to the deviating specification and the delivery takes place, or the order is cancelled. As an alternative to a cancellation, for example, the delivery date can be changed to a date on which goods that meet the specification are available.

On the part of the buyer, the presence of such a warning message can trigger, for example, a review of the deviating physical properties on the arrival of the goods. For example, such a warning message may require confirmation of the deviating physical properties by the buyer for a successful final validation of the goods delivery.

The second dataset is updated by the second DLT node using the result of the check of the one or more first sensor values of the outgoing goods log. For example, the update comprises entering the outgoing goods log and/or one or more of the sensor values specified by the outgoing goods log. For example, all sensor values specified by the outgoing goods log are entered. For example, only those sensor values are entered which deviate from the values entered in the second dataset for the physical properties of the goods to be delivered. For example, for sensor values of the outgoing goods log which match the values entered in the second dataset for the physical properties of the goods to be delivered, only a confirmation to the effect that the corresponding values for the physical properties match the acquired sensor values is entered into the second dataset.

In addition, a second update message is transferred from the second DLT node to the first DLT node. For example, the second update message includes the outgoing goods log and/or one or more of the sensor values indicated by the outgoing goods log. For example, the second update message includes all the sensor values indicated by the outgoing goods log. For example, the second update message includes only those sensor values which deviate from the values entered in the second dataset for the physical properties of the goods to be delivered. For example, for sensor values of the outgoing goods log which match the values entered in the second dataset for the physical properties of the goods to be delivered, the second update message includes only a confirmation to the effect that the corresponding values for the physical properties according to the shared dataset match the detected sensor values.

The first DLT node updates the first dataset, i.e. the first partial dataset of the shared dataset, using the second update message. For example, the update comprises entering the outgoing goods log and/or one or more of the sensor values indicated by the outgoing goods log. For example, all sensor values specified by the outgoing goods log are entered. For example, only those sensor values are entered which deviate from the values entered in the first dataset for the physical properties of the goods to be delivered. For example, for sensor values of the outgoing goods log which match the values for the physical properties of the goods to be delivered entered in the first dataset, only a confirmation to the effect that the corresponding values for the physical properties match the acquired sensor values is entered into the second dataset.

Finally, a validation of the goods delivery in the DLT system is performed. For this purpose, parameters of a validation message for validating the goods delivery are checked by the second DLT node. The checked parameters of the validation message include at least one indication of the quantity of delivered goods to be validated. Checking the corresponding parameters involves checking the quantity of goods to be validated for consistency with the sensor value quantifying the delivered quantity according to the outgoing goods log within a predefined tolerance. If the quantity of goods to be validated is consistent with the sensor value quantifying the delivered quantity of goods within the predefined tolerance, the second dataset is updated by the second DLT node using the validation message. The updating involves registering the validation message in the second dataset by means of the second DLT node. For example, in the course of the registration, an identifier of the validation message is entered into the second dataset. For example, a check value, such as a hash value, of the validation message is entered into the second dataset. For example, one or more parameters of the validation message are entered into the second dataset. For example, the validation message is entered into the second dataset.

A hash value is the result of an application of a hash function, also called a variance function, to an input, also called a key. A hash function is a representation that maps a large input set, the keys, to a smaller target set, the hash values. A hash function is therefore generally not one-to-one. The input set can contain elements of different lengths, for example, while the elements of the target set usually have a fixed length.

For example, the validation is triggered by receipt of the validation message or by generation of the validation message. For example, generation of the validation message is triggered by reception of a confirmation of receipt of the delivered goods from the buyer. For example, a receipt confirmation is received in the form of an incoming goods log.

In addition, the second DLT node sends a third update message to the first DLT node. For example, the third update message includes the validation message data entered into the second dataset during the update. For example, the third update message includes the complete updated second dataset. For example, the third update message includes the validation message.

The first DLT node updates the first dataset using the third update message. Updating the first dataset involves registering the validation message in the first dataset. For example, in the course of the registration, an identifier of the validation message is entered into the first dataset. For example, a check value, such as a hash value, of the validation message is entered into the first dataset. For example, one or more parameters of the validation message are entered into the first dataset. For example, the validation message is entered into the first dataset.

The processing with respect to the individual participants, i.e. the seller and the buyer, takes place on DLT nodes of the DLT system, which are assigned to the respective participants. For example, the DLT system comprises a plurality of DLT servers. For example, two or more DLT nodes of two or more participants can be arranged on the same DLT server of the DLT system. For example, the DLT nodes of different participants are arranged on different DLT servers of the DLT system.

For example, a single smart contract is used to carry out the method for the computer-implemented monitoring of the goods delivery. For example, a plurality of smart contracts is used. For example, each smart contract of the plurality of smart contracts is configured to perform specific sub-procedures, such as the initialising, logging, and/or validating.

A smart contract defines a series of conditions that are recorded in a DLT system and trigger automated, self-executing actions if at least some of these predefined conditions are met. A smart contract includes program instructions that represent agreed rules or corresponding conditions. Such a smart contract, which defines rules for a plurality of participants, cannot be changed unilaterally. Rather, a change requires, for example, a consensus of the plurality of participants. Such a consensus may require, for example, the consent of a majority of the plurality of participants and/or of all of the plurality of participants. For example, changes to the smart contract are logged. For example, this provides a complete history of the changes to the smart contract.

For example, the network used to access the DLT nodes can be a TCP/IP network. For example, the DLT nodes can be hosted on one or more servers. The DLT system can establish secure connections between the DLT servers and the DLT nodes hosted on them. For example, the DLT nodes can also be implemented by the participants locally on computer systems assigned to the participants.

The one or more first physical sensors of the seller comprise one or more physical measuring devices for detecting measurement data or sensor values. Measurement data is data that describe the physical and/or chemical properties of a measurement object in quantitative or qualitative terms. Appropriate properties include weight, volume, temperature, humidity, pressure, grain size, sound field variables, brightness, pH value, ionic strength, electrochemical potential, conductivity, viscosity, and/or translucency.

Measurement data is acquired by means of physical or chemical effects and converted into an electronically processable electrical signal. For example, the corresponding electrical signal, which includes the acquired measurement data, is cryptographically encrypted. For example, a symmetric, an asymmetric, or a hybrid cryptographic encryption can be used. This means that the corresponding measurement data can be protected against unauthorised access, for example. In addition, or alternatively, the corresponding electrical signal, which includes the acquired data, can be digitally signed. Thus, for example, the authenticity of the corresponding measurement data can be proven.

Embodiments may have the advantage that a bidirectional settlement of accounts can be implemented. This includes, for example, a 2-way match and/or a 3-way match. In addition, fully automatic invoicing is also possible, for example.

The 2-way match can be used to implement a unanimous declaration of intent with regard to delivery conditions for the goods delivery, such as physical properties of the delivered goods and/or a price of the goods to be delivered, using the at least one smart contract, and to document it using the DLT system.

The “2” in the name 2-way match means that the delivery order and order confirmation are validated. In the course of a 2-way match, delivery conditions for the goods delivery, such as physical properties of the delivered goods and/or a price of the goods to be delivered, are matched in accordance with the delivery order and order confirmation. This ensures that these match, i.e. are identical, or that any deviations that occur do not exceed a predefined tolerance range. This 2-way match is implemented by the second DLT node, for example, in the form of checking of information according to the order confirmation as it is entered into the second dataset. For example, the delivery order includes a first price indication of a price for the goods to be delivered. A price indication is an indication from which a payment for the goods to be delivered is obtained. For example, the price indication is the same as the price to be paid. For example, the price to be paid can be derived or calculated from the price indication. If the price indication refers to the total quantity of goods to be delivered, the price indication matches the price of the goods to be delivered. For example, the first price indication is a price indication per quantity of goods delivered. If a price indication is given per quantity of goods delivered, the actual price payable depends on the quantity of goods actually delivered. A price indication per quantity of goods delivered, e.g. per unit, per weight, or per volume, shall be multiplied by the quantity of goods delivered in order to determine the price to be paid for the goods delivered. For example, this first price according to the delivery order is entered into the first dataset by the first DLT node and transferred to the second DLT node for entry into the second dataset. For example, the order confirmation includes a second price indication of a price for the goods to be delivered, in particular a second price indication per quantity of goods delivered. For example, this second price indication according to the order confirmation is checked by the second DLT node for consistency with the first price indication and entered into the second dataset during the updating of the second dataset using the order confirmation. For example, this check can implement the 2-way match, or the 2-way match includes this check, for example. In the course of a 2-way match, a price for the goods to be delivered can thus be matched in accordance with the delivery order and order confirmation. In addition, the update message sent to the first DLT node about the updating of the second dataset by using the order confirmation includes the second price indication. For example, the second price indication thus transferred is entered into the second dataset by the second DLT node.

If the first price indication differs from the second price indication in such a way that they are not identical or if the difference exceeds a predefined tolerance range, for example, a handshake is initiated between the first DLT node and the second DLT node to match the price indications. For example, the price indications resulting from the matching are identical or have a remaining difference that does not exceed the predefined tolerance range.

With the 3-way match, delivery conditions resulting from the 2-way match, together with the information in the outgoing goods log regarding the goods actually delivered, can be compared with the corresponding information in the validation message and documented using the DLT system. One or more delivery conditions for the goods delivery, such as a price of the goods to be delivered, result from the 2-way match and are, for example, not the subject of the outgoing goods log. One or more delivery conditions for the goods delivery, such as physical properties of the delivered goods, may differ from the result of the 2-way match. The actual values for this delivery condition, such as a quantity of goods actually delivered, are therefore captured using the outgoing goods log. It can thus be checked whether there are any deviations from the result of the 2-way match and these deviations can be taken into account in the validation of the validation message. The “3” in the name 3-way match means that the basis for the corresponding validation in addition to the result of the 2-way match based on the delivery order and the order confirmation, is both the outgoing goods log and the validation message.

A real order contains information on certain physical properties of the goods to be delivered, which may be different in the actual delivery for reasons of efficiency and/or production. For example, a real order also includes information on certain physical properties, which may be different in the actual delivery due to naturally occurring variation. For this reason, for example, physical properties of the goods to be delivered are acquired using sensors during delivery by the seller and logged in the outgoing goods log. These physical properties of the delivered goods acquired using sensors according to the outgoing goods log are recorded in the shared dataset of the DLT system, for example as physical properties of the goods actually delivered, and taken as a basis for checking the validation message.

For example, a real order defines a specific quantity of the ordered goods to be delivered. For reasons of efficiency, however, it may be advantageous to completely fill transport vehicles for transporting the goods to be delivered, for example in the case of bulk goods, so that the actual quantity delivered can deviate from the quantity ordered. For example, a larger quantity than ordered will be delivered. This actual delivered quantity can be detected, for example, using sensors and logged in the outgoing goods log. For example, a real order defines certain physical properties of the ordered goods. Due to production conditions, however, only goods with physical properties that deviate from the properties defined in the order can be produced, for example. In this case, for example, either the buyer must agree to the deviating specification and the delivery takes place, or the order is cancelled. For example, production of the goods to be delivered with the specific physical properties might be temporarily not possible, for example, because necessary initial products and/or initial starting products with specific necessary physical properties are temporarily unavailable for production. It may also be possible that certain means of production, such as plants or parts of plants, may be temporarily unavailable for production. In this case, as an alternative to a cancellation, there is, for example, the option of changing the delivery date to a date on which goods meeting the specifications are available or can be produced.

For example, in the course of the 3-way match, a price indication of a price of the goods to be delivered, in particular a price indication per quantity of goods which results from the 2-way match, and an indication of the actual quantity of goods delivered, which is included in the outgoing goods log, are compared with corresponding indications for price and quantity of goods contained in the validation message. In addition or alternatively, a total price for the delivered goods is determined from a price indication per quantity of goods, which results from the 2-way match, and the indication of the actual quantity of goods delivered included in the outgoing goods log, and this total price is compared with a corresponding indication for the total price contained in the validation message. For example, the validation message is created using the smart contract, wherein during the 3-way match it can be ensured that the specifications of the delivery conditions in the validation message are consistent with the delivery conditions agreed on the basis of the delivery order and the order confirmation as well as the actual delivery conditions according to the outgoing goods log. In addition, a payment of an invoice amount resulting from the validation message can be triggered, for example, using the smart contract. A corresponding check of the validation message using the smart contract can thus replace a classical invoice check.

The above-mentioned approach may be advantageous in particular for delivery, such as mass product deliveries, in which delivery conditions of a delivery order and/or an order confirmation may differ, such as an actual delivered final quantity. In this case, the actual delivery conditions can be determined on the basis of the outgoing goods log. In other cases, the delivery conditions are set as actually invariable. For example, in the case of packaged goods, the quantity of the goods to be delivered is determined by the order confirmation or the result of a handshake between the seller and the buyer. The corresponding defined delivery conditions can therefore be taken from the order confirmation or the result of the 2-way match, for example. In such a case, the 3-way match is used to check the correspondingly adopted delivery conditions in the validation message by using the outgoing goods log. For example, during validation, errors regarding the actual delivery conditions can be identified and it can be ensured that these are taken into account in the validation message or that the validation message is based on the actual delivery conditions. In this case, corresponding deviations or errors can trigger a sending of a warning message and/or a correction based on the validation message, for example by a re-delivery or a delivery of the correct goods by the seller.

The system works in such a way that the signals supplied by the sensors in the form of the outgoing goods log and/or an incoming goods log are evaluated by the one or more smart contracts, compared against the status of the ordering or goods delivery process according to the shared dataset, and logged in the shared dataset. In addition, a transfer of the payment amount between eWallets or electronic wallets is initiated using the one or more smart contract, either semi-automatically or fully automatically. Preferably the transfer of the payment amount of digital money is initiated between eWallets or electronic wallets of seller and buyer by using at least one smart contract.

According to embodiments, the method further comprises signing the data transferred from the first DLT node to the second DLT node by the first DLT node. The at least one smart contract is configured on the second DLT node to verify the signatures of the transferred data.

Embodiments may have the advantage that by using the corresponding signatures, it is possible to verify the authenticity of data that the first DLT node transfers to the second DLT node. This ensures that the second dataset is updated by the second DLT node based on data that is signed and hence authorised by the first DLT node. For example, the first DLT node uses a first signature key to sign the data. For example, this first signature key is a first private cryptographic key of a first asymmetric cryptographic key pair. For example, this first signature key is stored in a protected memory area of the first DLT node. For example, the second DLT node and/or the smart contract executed on the second DLT node comprises a first signature verification key for validating signatures which were created using the first signature key. For example, this first signature verification key is a first public cryptographic key of the first asymmetric cryptographic key pair.

Data protection can be implemented or increased, for example, using cryptographic means such as hashing and/or encryption.

An asymmetric cryptographic key pair includes a public cryptographic key that is shared with or disclosed to third parties, and a private cryptographic key that is not shared with third parties or disclosed to third parties. The public cryptographic key enables the third party to decrypt data that was encrypted by the owner of the asymmetric key pair with the private cryptographic key.

Furthermore, the public cryptographic key enables the third party to encrypt data so that only the owner of the asymmetric key pair is able to decrypt the encrypted data with the private cryptographic key. The private key, on the other hand, is used by the owner of the asymmetric key pair to encrypt data so that it can be decrypted by third parties by using the public cryptographic key. Furthermore, the private cryptographic key is used by the owner of the asymmetric key pair data to decrypt data intended for him that was encrypted with the public cryptographic key. Thus, for example, the private cryptographic key enables the owner of the asymmetric key pair to sign data, while the public cryptographic key allows any third party to verify a corresponding signature.

A digital signature is an asymmetric encryption system in which a sender uses a secret signature key, i.e. a private cryptographic key, to calculate a value associated with a digital message, which is also called a digital signature. This value allows anyone to use a public signature verification key, i.e. a public cryptographic key, to check a non-deniable authorship of the owner of the signature key and integrity of the message.

For example, the signature can be an encrypted hash value of the signed data, in particular a hash value encrypted with a private cryptographic key. For example, the private cryptographic key is associated with a public cryptographic key, which serves as a signature verification key. For example, the public cryptographic key is provided as part of a certificate.

A “certificate” here refers to a digital certificate, which is also referred to as a public key certificate. Such certificates, based on asymmetric key pairs, implement a so-called Public Key Infrastructure (PKI). Such a certificate involves structured data that is used to assign a public key of an asymmetric encryption system to an entity, such as a person, an organisation, a computer system, or a DLT node. For example, a certificate may contain a public key and be signed. For example, the certificate may conform to the X.509 standard or some other standard.

PKI provides a system for issuing, distributing, and verifying digital certificates. A digital certificate is used in an asymmetric encryption system to confirm or define the authenticity of a public key and its allowable scope of application and validity. The digital certificate is itself protected by a digital signature, the authenticity of which can be verified with the public key of the certificate issuer. A digital certificate is again used to verify the authenticity of the issuer key. This enables a chain of digital certificates to be set up, each of which confirms the authenticity of the public key used to validate the preceding certificate. Such a chain of certificates forms a so-called validation path or certification path. The participants of the PKI must be able to rely on the authenticity of the last certificate, the so-called root certificate, and of the key certified by this certificate, without having to use another certificate. The root certificate is managed by a so-called root certification authority, the authenticity of which, assumed to be secured, is the basis for the authenticity of all PKI certificates.

A certificate can be assigned to a digital signature if the private cryptographic key belonging to the public cryptographic key has been used to generate the digital signature to be verified. By providing a certificate in association with a public key to the general public, users of asymmetric encryption systems are allowed to map the public key to an entity, such as a person, organisation, computer system, or DLT node.

According to embodiments, the method further comprises signing the data transferred from the second DLT node to the first DLT node by the second DLT node. The at least one smart contract is configured on the first DLT node to verify the signatures of the transferred data.

Embodiments may have the advantage that by using the corresponding signatures, it is possible to verify the authenticity of data that the second DLT node transfers to the first DLT node. This ensures that the first dataset is updated by the first DLT node based on data that is signed and hence authorised by the second DLT node. For example, the second DLT node uses a second signature key to sign the data. For example, this second signature key is a second private cryptographic key of a second asymmetric cryptographic key pair. For example, this second signature key is stored in a protected memory area of the second DLT node. For example, the second DLT node and/or the smart contract executed on the second DLT node comprises a second signature verification key for validating signatures that were created using the second signature key. For example, this second signature verification key is a second public cryptographic key of the second asymmetric cryptographic key pair.

According to embodiments the data transfer between the first DLT node and the second DLT node is carried out via one or more communication links cryptographically protected using end-to-end encryption,

Embodiments may have the advantage that it can be ensured that data transferred between the DLT nodes within the DLT system is effectively protected against man-in-the-middle attacks. For example, the encryption may be a symmetric encryption, an asymmetric encryption, or a hybrid encryption. For example, encryption is carried out using the TLS encryption protocol.

According to embodiments, establishing the one or more cryptographically protected communication connections, for example, comprises a mutual authentication of the first DLT node and the second DLT node.

Embodiments may have the advantage that, based on the mutual authentication, both DLT nodes can ensure with whom they communicate over the corresponding communication links. This allows the first DLT node of the buyer to ensure that it is actually communicating with the DLT node that is assigned to the seller, i.e. the second DLT node. In addition, the second DLT node of the seller can ensure that it is actually communicating with the DLT node that is assigned to the buyer, i.e. the first DLT node.

According to embodiments, the checking of the second specification for consistency with the first specification in the course of the initialisation is an identity check. Embodiments may have the advantage that it can be ensured that identity exists between the first specification according to the delivery order and the second specification according to the order confirmation. Such an identity means that the buyer and the seller have agreed on an identical specification of the goods to be delivered. In this case, for example, both partial records of the shared dataset store identical specifications. If the first and second specifications differ from each other, by using the at least one smart contract, for example, a handshake protocol can be executed between the two DLT nodes, the result of which is an adjustment of one or both specifications until an identity exists.

According to embodiments, the initialisation further comprises, if the one or more physical properties according to the second specification that are entered into the second dataset differ from the one or more physical properties according to the first specification from the first dataset, performing a handshake between the first DLT node and the second DLT node to match the first specification of the first dataset and the second specification of the second dataset, so that the first and second specifications resulting from the matching are the same.

The handshake can be, for example, an automatic or a semi-automatic handshake. In the case of an automatic handshake, for example, tolerance ranges for the parameters to be negotiated are defined for the buyer and the seller. In this case, deviations between parameters can be achieved by matching them within the respective tolerance ranges. In the case of a semi-automatic handshake, a proposal is received from one of the two subscribers or from a DLT node assigned to the corresponding subscriber, for a parameter value which differs from a separate proposal by the corresponding subscriber for the corresponding parameter. This differing parameter value can be confirmed, for example, by receiving a user input from the corresponding subscriber. If the corresponding parameter value is confirmed by user input, a confirmation of the proposed parameter value can also be sent to the proposing second subscriber in the course of the handshake. Alternatively, a counter-proposal for the differing parameter value can be received by receiving a user input from the corresponding subscriber. In the course of the handshake, this counter-proposal for the differing parameter value can be sent to the second subscriber. The second subscriber either confirms the counter-proposal by sending a corresponding confirmation in the course of the handshake, or makes a new counter-proposal. This procedure can be continued, for example, until agreement is reached on the corresponding parameter value or until a predefined termination criterion is met. For example, a corresponding termination criterion can be a predefined maximum number of proposals for a parameter value, an expiration of a predefined maximum period of time to negotiate a parameter value, or a receipt of a user input that explicitly rejects a current proposal for the corresponding parameter value.

The handshake can be executed or at least initiated by the one or more smart contracts. Preferably, iterations of the automatic or semi-automatic handshake between the DLT nodes of the negotiating partners can take place by entering proposals in the respectively managed part of the shared dataset, which is then transferred to the DLT node of the negotiating partner. All changes thus remain traceable and can be reviewed by the negotiating partners. There is therefore transparency between the negotiating partners about the parameters to be negotiated, as the separate proposal is entered in the separate part of the shared dataset and the counter-proposal is entered in the other part of the shared dataset.

Embodiments may have the advantage that an effective method for matching different specifications according to the delivery order and order confirmation, i.e. different proposals for the specification between buyer and seller, can be provided.

According to embodiments the checking of the second specification for consistency with the first specification during the initialisation is a check for consistency within predefined third tolerances in accordance with the at least one smart contract.

Embodiments may have the advantage that there is no need for the specifications to be identical. This allows deviations within predefined tolerances. For example, the seller can adjust the specification of the goods to be delivered, such as a quantity of goods to be delivered, within predefined limits, i.e. the tolerances, to match their capability to deliver the requested goods.

According to embodiments, the initialisation further comprises performing a handshake between the first DLT node and the second DLT node for matching the first specification of the first dataset and the second specification of the second dataset, in case one or more deviations between the one or more physical properties according to the second specification, which are entered into the second dataset, and the one or more physical properties according to the first specification from the first dataset are greater than the predefined third tolerances. The handshake causes the first and second specifications resulting from the matching to match each other within the predefined third tolerances.

Embodiments may have the advantage that an effective method for matching different specifications according to the delivery order and order confirmation, i.e. different proposals for the specification between buyer and seller, can be provided. For example, using the at least one contract, a handshake protocol is implemented between the two DLT nodes, resulting in an adjustment of one or both specifications until deviations between the two specifications are only within the corresponding predefined tolerances.

According to embodiments, the program instructions included in the at least one smart contract are further configured for entering and checking incoming goods logs in the course of goods deliveries from the seller to the buyer. The logging of the goods delivery in the DLT system also comprises:
receiving an incoming goods log from the buyer via the first network by means of the first DLT node, wherein the incoming goods log comprises one or more second sensor values for the one or more physical properties of the incoming goods according to the first specification, which are acquired by means of one or more second physical sensors assigned to the buyer, wherein the one or more second sensor values comprise at least one second sensor value which quantifies the delivered quantity of goods,
checking the one or more second sensor values of the incoming goods log for consistency with the one or more physical properties of the goods to be delivered according to the shared dataset and with the one or more first sensor values according to the outgoing goods log within predefined fourth tolerances by using the at least one smart contract, wherein the second sensor values checked comprise at least the second sensor value quantifying the quantity of goods delivered,
performing a fourth update of the first dataset by means of the first DLT node by using a third result of checking the one or more second sensor values of the incoming goods log,
transferring at least one fourth update message from the first DLT node to the second DLT node,
performing a fifth update of the second dataset by means of the second DLT node by using the fourth update message.

Embodiments may have the advantage that the logging of the goods delivery, in addition to the outgoing goods log of the seller of the goods about the goods actually sent, also includes an incoming goods log of the buyer about the goods actually received.

If the physical goods delivery is received by the buyer, i.e. if the goods to be delivered reach a warehouse of the buyer, an incoming goods log is created. The corresponding incoming goods log comprises one or more sensor values for the one or more physical properties of the incoming goods according to the first specification, which are acquired by means of one or more physical sensors assigned to the buyer. The incoming goods log therefore specifies for one or more physical properties, for which target values are specified in the first specification, measured values acquired by sensors in each case, which reflect the actual status of the incoming goods with regard to the corresponding physical properties. The corresponding sensor values include at least one sensor value which quantifies the delivered, i.e. incoming, quantity of goods.

The first DLT node of the seller receives the incoming goods log from the seller via the first network and checks the one or more first sensor values of the incoming goods log for consistency with the one or more physical properties of the goods to be delivered. In this process, it is checked whether the one or more sensor values of the incoming goods log are consistent with one or more physical properties according to the shared dataset within predefined tolerances. If no such consistency is present, for example, a warning message is sent to the buyer and/or the seller. Such a warning message can, for example, trigger a re-delivery by the seller if the delivery quantity is too little. On the part of the buyer, for example, such a warning message may require confirmation of the deviating physical properties by the buyer for a successful final validation of the goods delivery.

The first dataset is updated by the first DLT node using the result of the check of the one or more first sensor values of the incoming goods log. For example, the update comprises entering the incoming goods log and/or one or more of the sensor values indicated by the incoming goods log. For example, all sensor values specified by the incoming goods log are entered. For example, only those sensor values are entered which deviate from the values entered in the first dataset for the physical properties of the goods to be delivered. For example, for sensor values of the incoming goods log which match the values for the physical properties of the goods to be delivered entered in the first dataset, only a confirmation to the effect that the corresponding values for the physical properties match the acquired sensor values is entered into the second dataset.

In addition, a fourth update message is transferred from the first DLT node to the second DLT node. For example, the fourth update message includes the incoming goods log and/or one or more of the sensor values specified by the incoming goods log. For example, the fourth update message includes all the sensor values specified by the incoming goods log. For example, the fourth update message includes only those sensor values which deviate from the values entered in the first dataset for the physical properties of the goods to be delivered. For example, for sensor values of the incoming goods log which match the values entered in the first dataset for the physical properties of the goods to be delivered, the fourth update message includes only a confirmation to the effect that the corresponding values for the physical properties according to the shared dataset match the detected sensor values.

The second DLT node updates the second dataset, the second partial dataset of the shared dataset, using the fourth update message. For example, the update comprises entering the incoming goods log and/or the one or more of the sensor values indicated by the incoming goods log. For example, all sensor values specified by the incoming goods log are entered. For example, only those sensor values are entered which deviate from the values entered in the second dataset for the physical properties of the goods to be delivered. For example, for sensor values of the incoming goods log which match the values for the physical properties of the goods to be delivered entered in the second dataset, only a confirmation to the effect that the corresponding values for the physical properties match the acquired sensor values is entered into the second dataset.

The one or more second physical sensors of the seller comprise one or more physical measuring devices for acquiring measurement data or sensor values. Measurement data is data that describes physical and/or chemical properties of a measurement object in quantitative or qualitative terms. Appropriate properties include weight, volume, temperature, humidity, pressure, grain size, sound field variables, brightness, pH value, ionic strength, electrochemical potential, conductivity, viscosity, and/or translucency. Measurement data is acquired by means of physical or chemical effects and converted into an electronically processable electrical signal. For example, the corresponding electrical signal, which includes the acquired measurement data, is cryptographically encrypted. For example, a symmetric, an asymmetric, or a hybrid cryptographic encryption can be used. This means that the corresponding measurement data can be protected against unauthorised access, for example. In addition, or alternatively, the corresponding electrical signal, which includes the acquired data, can be digitally signed. Thus, for example, the authenticity of the corresponding measurement data can be proven.

According to embodiments, the validation message includes an invoice. Embodiments may have the advantage that in the course of checking the validation message an invoice for the goods delivery is checked. This ensures that the specifications of the invoice for the physical properties of the delivered goods match the actual physical properties of the delivered goods. In particular, it can thus be ensured that the details on the quantity of the delivered goods on which the invoice is based are consistent with a quantity of the goods actually delivered.

According to embodiments, the program instructions included in the at least one smart contract are also configured for generating the invoice. The second DLT node generates the invoice using the at least one smart contract. The validation message parameters can be checked during the generation of the invoice.

Embodiments can have the advantage that an invoice generation can be integrated directly in the course of the validation of the goods delivery. Once the created invoice is registered in the DLT system, for example, the monitoring of the goods delivery is successfully completed.

Using the one or more smart contract, for example, additional charges and taxes, such as VAT, can be calculated for the invoice amount and added to it during the invoicing process.

According to embodiments the invoice is received from a first ERP system of the seller that generates the invoice. Embodiments may have the advantage that the DLT system can be combined with an ERP system, for example an existing ERP system, of the seller. The DLT system or shared dataset managed by the DLT system represents a single point of truth for the goods delivery. For example, to validate the invoice, registration at least in the second dataset on the second DLT node is required. For example, the registration involves entering an invoice number of the invoice into the second dataset.

For example, both the seller and the buyer each have independent ERP systems, while the shared dataset provided in the DLT system serves as a single point of truth for both parties involved, i.e. the buyer and the seller.

An ERP system refers to an application software or IT system or a plurality of intercommunicating application software or IT systems that are used to support resource planning of a business. Complex ERP systems are, for example, integrated into subsystems, i.e. application modules, which can be combined as required. Enterprise Resource Planning (ERP) refers to the business task of planning, controlling and managing personnel and resources such as capital, equipment, materials and information and communication technology in a timely and demand-compliant manner.

A core function of ERP in manufacturing companies is material requirements planning to ensure that all the materials required to manufacture products and/or components are available in the right place, at the right time, and in the right quantity.

For example, the ERP systems of the seller and the buyer can be configured to create and/or compile relevant data for the goods delivery and to make this data available to the DLT system. For example, the ERP system of the buyer creates the delivery order and/or the incoming goods log and sends it/them to the first DLT node. For example, the ERP system of the seller creates the order confirmation, the outgoing goods log and/or the validation message and sends them to the second DLT node.

According to embodiments, the data entered in the shared dataset provided in the DLT system in the course of logging the goods delivery is mirrored data of the goods delivery from the first ERP system of the seller and/or a second ERP system of the buyer. The first and/or second ERP system is/are configured to control the processing of the goods delivery. Entering the mirrored data ensures data consistency between the shared dataset and the ERP systems.

Embodiments may have the advantage that data consistency can be implemented between the shared dataset and the ERP systems of the seller and/or buyer. The shared dataset thus represents a single point of truth for both subscribers or their mutually independent ERP systems. For example, the first DLT node receives the delivery order from the ERP system of the buyer. For example, the second DLT node receives the delivery order from the ERP system of the seller. The data entered in the shared dataset reflects the data for the goods delivery stored in the first and/or second ERP system.

According to embodiments, the processing of the goods delivery is controlled by the at least one smart contract, the program instructions of which are also configured to control the processing of the goods delivery.

Embodiments may have the advantage that the goods delivery can be processed by the at least one smart contract. In this case, for example, neither the buyer nor the seller of the goods requires an ERP system to process the goods delivery. For example, a computer system of the buyer can send the delivery order directly to the first DLT node via the first network, or the first DLT node can receive the delivery order directly from the buyer's computer system. For example, a computer system of the seller can send the order confirmation via the first network directly to the second DLT node.

According to embodiments, the first network is a public network, for example. For example, the first network is the Internet or another existing wide area network, for example, a wireless or Ethernet-based network within a company or between participating companies.

Similarly, according to embodiments, the first network may be, for example, an intranet.

According to embodiments, a prerequisite for receiving the delivery order of the buyer by means of the first DLT node is a successful authentication of the buyer by the first DLT node. Embodiments may have the advantage that the first DLT node can ensure by means of a successful authentication of the buyer that the delivery order actually originates from and is authorised by the buyer. For example, authentication can be carried out using a first user name and first password, which the buyer must specify in order to successfully authenticate against the first DLT node. Further authentication methods, for example by means of cryptographic methods, chip cards and/or biometric data, may also be provided.

According to embodiments, a prerequisite for receiving the order confirmation of the seller by means of the second DLT node is a successful authentication of the seller by the second DLT node. Embodiments may have the advantage that the second DLT node can ensure by means of a successful authentication of the seller that the order confirmation actually originates from and is authorised by the seller. For example, authentication can be carried out using a second user name and second password, which the buyer must specify in order to successfully authenticate against the first DLT node. Further authentication methods, for example by means of cryptographic methods, chip cards, and/or biometric data may also be provided.

According to embodiments, a prerequisite for receiving the outgoing goods log of the seller by means of the second DLT node is a successful authentication of the seller by the second DLT node. Embodiments may have the advantage that the second DLT node can ensure by means of a successful authentication of the seller that the outgoing goods log actually originates from and is authorised by the seller. For example, authentication can be carried out using a second user name and second password, which the buyer must specify in order to successfully authenticate against the first DLT node. Further authentication methods, for example by means of cryptographic methods, chip cards, and/or biometric data may also be provided.

According to embodiments, a prerequisite for receiving the incoming goods log of the buyer by means of the first DLT node is a successful authentication of the buyer by the first DLT node. Embodiments may have the advantage that the first DLT node can ensure by means of a successful authentication of the buyer that the incoming goods log actually originates from and is authorised by the buyer. For example, authentication can be carried out using a first user name and first password, which the buyer must specify in order to successfully authenticate against the first DLT node.

According to embodiments, a prerequisite for the use of the delivery order of the buyer by the first DLT node is a successful signature check of a signature of the delivery order by the first DLT node.

Embodiments can have the advantage that the authenticity of the delivery order can be checked using the signature of the delivery order, i.e. the first DLT node can check whether the received delivery order is actually authorised by the buyer. For example, the buyer uses a third signature key to sign the delivery order. For example, this third signature key is a third private cryptographic key of a third asymmetric cryptographic key pair. For example, the first DLT node and/or the smart contract executed on the first DLT node comprises a third signature verification key for validating signatures of the buyer, which were created using the third signature key. For example, this third signature verification key is a third public cryptographic key of the third asymmetric cryptographic key pair.

According to embodiments, a prerequisite for the use of the order confirmation of the buyer by the second DLT node is a successful signature check of a signature of the order confirmation by the second DLT node.

Embodiments can have the advantage that the authenticity of the order confirmation can be checked using the signature of the order confirmation, i.e. the second DLT node can check whether the received order confirmation is actually authorised by the seller. For example, to sign the order confirmation, the seller uses a fourth signature key. For example, this fourth signature key is a fourth private cryptographic key of a fourth asymmetric cryptographic key pair. For example, the second DLT node and/or the Smart Contract executed on the second DLT node comprises a fourth signature verification key for validating signatures of the seller, which were created using the fourth signature key. For example, this fourth signature key is a fourth public cryptographic key of the fourth asymmetric cryptographic key pair.

According to embodiments, a prerequisite for the use of the outgoing goods log of the seller by the second DLT node is a successful signature check of a signature of the outgoing goods log by the second DLT node.

Embodiments can have the advantage that the authenticity of the outgoing goods log can be checked using the signature of the outgoing goods log, i.e. the second DLT node can check whether the received outgoing goods log is actually authorised by the seller. For example, to sign the order confirmation, the seller uses the fourth signature key, the signatures of which the second DLT node can validate with the fourth signature verification key.

According to embodiments, a prerequisite for the use of the incoming goods log of the buyer by the first DLT node is a successful signature check of a signature of the incoming goods log by the first DLT node.

Embodiments can have the advantage that the authenticity of the incoming goods log can be checked using the signature of the incoming goods log, i.e. the first DLT node can check whether the received incoming goods log is actually authorised by the buyer. For example, to sign the incoming goods log, the buyer uses the third signature key, the signatures of which can be validated by the first DLT node using the signature verification key.

According to embodiments the first DLT node and the second DLT node are provided by one or more DLT servers of the DLT system. For example, the first DLT node and the second DLT node are implemented on the same DLT server of the DLT system. For example, the first DLT node and the second DLT node are implemented on two different DLT servers in the DLT system.

According to embodiments, the one or more DLT servers of the DLT system are arranged in one or more data centres secured against unauthorised access. Embodiments may have the advantage that unauthorised physical access to the DLT servers to the DLT servers and thus to the DLT nodes implemented on the DLT servers can be prevented by the access security. This physical access or access protection can be implemented, for example, in addition to cryptographic access protection, which prevents unauthorised access to the DLT servers or the DLT nodes via the first network, such as the internet. For example, this cryptographic access protection comprises successful authentication as a prerequisite for accessing the DLT nodes over the first network. For example, the authentication requires the correct entry of a user name and password for the subscriber, such as the seller or buyer, to whom the corresponding DLT node is assigned. For example, a successful authentication requires multi-factor authentication, such as two-factor authentication.

Data centre access security comprises, for example, monitoring access to the data centre and using an alarm system to secure the data centre premises. The alarm system comprises, for example, an intrusion alarm system (EMA), i.e. an electronically operated device, which serves to protect objects. An intrusion alarm system is designed, for example, to prevent intrusions by deterrence, and in the event of intrusion to notify services providing assistance, such as the police and/or a private security service, to minimise the action time of intruders, to alert an immediate environment as well as involved persons present, and/or to reconstruct an actual intrusion.

According to embodiments, the data transfer between the DLT nodes takes place via a second network.

For example, the second network is a network different from the first network. For example, the second network is a network independent of the first network. For example, the second network is the same network as the first network.

According to embodiments, the second network is a private or a public network. For example, in the case of a private network, the second network is an intranet. For example, in the case of a public network, the second network is the Internet.

According to embodiments, the program instructions comprised by the at least one smart contract are further configured for triggering an electronic payment transaction. The payment transaction by the smart contract is triggered upon the registration of the validation message in the DLT system.

Embodiments can have the advantage that payments and bookings can be made in real time. Embodiments may also have the advantage that by registering the validation message in the DLT system, i.e. on a successful validation of the goods delivery in the DLT system, an electronic payment transaction is triggered. For example, the payment transaction is triggered when the validation message is registered in the first dataset and/or the second dataset. For example, the registered validation message determines the amount of the electronic payment transaction to be paid.

Payment transactions can be coupled with data streams from the validation and kept in a closed data circuit.

According to embodiments, the triggered electronic payment transaction is a transfer from a bank account of the buyer to a bank account of the seller.

According to embodiments, the triggered electronic payment transaction is a bank account transfer (e.g., IBAN transfer) from an account of the buyer to an account of the seller.

According to embodiments, the triggered electronic payment transaction is a transaction of an amount of digital money performed using the DLT system.

Embodiments may have the advantage that the transaction of the amount of digital money can take place within the DLT system. Thus, the transaction can be triggered by registering the validation message and executed directly in the DLT system, for example using the at least one smart contract.

Digital money refers to a digital form of money, in which the user can program inherent logics for conditional uses on the basis of attributes of the digital money itself. Examples of this include triggering a transaction after one or more conditions have been met, such as time, location, type of use, etc. “Digital money” is also named and known as conditional and/or digital money for conditional payments.

For example, a payment infrastructure is provided that allows the seller and buyer to share a programmable currency. In addition, for example, validation of the goods delivery and invoicing can be carried out in a closed data circuit.

According to embodiments, the DLT system is configured to transfer the payable invoice amount from an account of the buyer for digital money to an account of the seller for digital money. Preferably, the DLT system may be configured to transform a fiat money amount of a fiat money account assigned to the buyer into an amount of the digital money on the eWallet of the buyer for digital money. “fiat money” is also named and known as e.g., bank money, deposit money or book money. Furthermore, the DLT system may be configured to transform, at least partially, the invoice amount transferred in the form of digital money on the account of the seller for digital money into a bank money amount on a bank account assigned to the seller.

Embodiments may have the advantage that the transaction can be processed by means of digital money. For this purpose, the bank money amount of the buyer can be transformed into an amount of digital money, which is at least partially used for payment of the delivered goods. The invoice amount received by the seller as payment for the delivered goods in the form of digital money can then be transformed into a bank money amount. This bank money amount can be credited to the seller on a bank account assigned to the seller.

money is a classical currency, i.e. a state-defined means of exchange and payment, which is artificially created, unbacked and not limited. In other words, it is an economic instrument without any intrinsic value, which serves as a means of exchange.

According to embodiments, the payment transaction is logged in the DLT system using the at least one smart contract. Using the Smart Contract, electronic account statements relating to the logged payment transaction are also issued to the buyer and/or seller of the goods.

Embodiments may have the advantage that, in addition to executing the electronic payment transaction, electronic account statements relating to the corresponding payment transaction are also issued to the buyer and/or the seller of the goods. For example, the bank statements are issued in accordance with the MT940 standard. MT940 (MT=Message Type) is the SWIFT standard (Society for Worldwide Interbank Financial Telecommunication) or Banking Communication Standard for the electronic transfer of account statement data.

Further embodiments comprise a shared dataset of an access-restricted DLT system for computer-implemented monitoring of a goods delivery from a seller to a buyer by using the DLT system. The shared dataset contains a first part. The first part is a first dataset managed by a first DLT node assigned to the buyer. The shared dataset also comprises a second part. The second part is a second dataset managed by a second DLT node assigned to the seller.

For example, the first dataset of the first part contains information on one or more physical properties of the goods to be delivered from a delivery order as a first specification. The physical properties of the first specification include at least one quantity of goods to be delivered. For example, the first dataset of the first part contains information on a second specification of the one or more physical properties of the goods to be delivered according to an order confirmation. For example, the first dataset of the first part includes a check result of checking the second specification. For example, the first dataset of the first part comprises one or more first sensor values for the one or more physical properties of the goods according to an outgoing goods log, which are acquired by means of one or more physical sensors assigned to the seller. The one or more first sensor values comprise at least one first sensor value, which quantifies the delivered quantity of goods. For example, the first dataset of the first part comprises a check result of checking the first sensor values of the outgoing goods log. For example, the first dataset of the first part comprises one or more second sensor values for the one or more physical properties of the goods according to an outgoing goods log, which are acquired by means of one or more physical sensors assigned to the buyer. The one or more second sensor values comprise at least one second sensor value, which quantifies the delivered quantity of goods. For example, the first dataset of the first part comprises a check result of checking the second sensor values of the outgoing goods log. For example, the first dataset of the first part comprises a registration of a validation message to validate the goods delivery. For example, the registration includes information about one or more parameters of the validation message. For example, the parameters include at least one quantity of goods to be validated. For example, the first dataset of the first part comprises a check result of checking the parameters of the validation message.

For example, the second dataset of the second part contains information on one or more physical properties of the goods to be delivered from a delivery order as a first specification. The physical properties of the first specification include at least one quantity of goods to be delivered. For example, the second dataset of the second part contains information on a second specification of the one or more physical properties of the goods to be delivered according to an order confirmation. For example, the second dataset of the second part includes a check test result of a check of the second specification. For example, the second dataset of the second part comprises one or more first sensor values for the one or more physical properties of the goods according to an outgoing goods log, which are detected by means of one or more physical sensors assigned to the seller. The one or more first sensor values comprise at least one first sensor value, which quantifies the delivered quantity of goods. For example, the second dataset of the second part comprises a check result of checking the first sensor values of the outgoing goods log. For example, the second dataset of the second part comprises one or more second sensor values for the one or more physical properties of the goods according to an incoming goods log, which are detected by means of one or more physical sensors assigned to the buyer. The one or more second sensor values comprise at least one second sensor value, which quantifies the delivered quantity of goods. For example, the second dataset of the second part comprises a check result of a check of the second sensor values of the outgoing goods log. For example, the second dataset of the second part comprises a registration of a validation message to validate the goods delivery. For example, the registration includes information about one or more parameters of the validation message. For example, the parameters include at least one quantity of goods to be validated. For example, the second dataset of the second part comprises a check result of checking the parameters of the validation message.

For example, the shared dataset is the result of executing one or more of the aforementioned method steps of the method for computer-implemented monitoring of the goods delivery. For example, the shared dataset is the result of executing each of the aforementioned method steps of the method for computer-implemented monitoring of the goods delivery.

The shared dataset, which is distributed over two DLT nodes and includes the two (partial) datasets of the buyer and the seller, can have the advantage of providing an effective approach to the confidential processing of transactions between the two DLT nodes. In addition, such a shared dataset enables effective transaction protection and increases the data security between the DLT nodes.

The shared dataset may be used in any method according to one or more embodiments of the present description. Furthermore, the dataset may be the object of the above methods and may be processed and updated by them.

Further embodiments comprise the use of a shared dataset according to one or more embodiments of the present description for initialising the goods delivery in the DLT system. The shared dataset can be used for an initialisation in any method according to one or more embodiments of the present description.

Further embodiments comprise the use of a shared dataset according to one or more embodiments of the present description for logging the goods delivery in the DLT system. The shared dataset can be used for a logging process in any method according to one or more embodiments of the present description.

Further embodiments comprise the use of a shared dataset according to one or more embodiments of the present description for validating the goods delivery in the DLT system. The shared dataset can be used for a validation process in any method according to one or more embodiments of the present description.

Further embodiments comprise a DLT node of an access-restricted DLT system for the computer-implemented monitoring of a goods delivery from a seller to a buyer. The DLT node is implemented on a DLT server of the DLT system and assigned to the buyer. The DLT server comprises a processor and memory with program instructions. The program instructions provide at least one smart contract on the DLT node. The program instructions that provide the at least one smart contract include program instructions for entering and checking delivery orders and order confirmations.

Execution of the program instructions by the processor causes the processor to control the DLT node in such a way that in the course of initialising the goods delivery in the DLT system the DLT node executes the following:
receiving a delivery order of the buyer relating to goods to be delivered from the seller to the buyer via a first network by means of the first DLT node, wherein the delivery order defines one or more physical properties of the goods to be delivered as a first specification, the physical properties of the first specification comprising at least one quantity of goods to be delivered,
creating a first dataset managed by the DLT node and entering at least the one or more physical properties of the delivery order into the first dataset by means of the DLT node by using the at least one smart contract, wherein the first dataset is a first part of a dataset shared between the first DLT node and a further DLT node of the DLT system, assigned to the seller,
transferring at least the first dataset from the DLT node to the further DLT node,
receiving at least one first update message from the further DLT node via an update of the second dataset using a first check result of checking a second specification of the one or more physical properties of the goods to be delivered according to an order confirmation for consistency with the first specification,
performing a first update of the first dataset by means of the DLT node by using the first update message.

Further embodiments comprise a DLT node, wherein the program instructions providing the at least one smart contract comprise program instructions for entering and checking outgoing goods logs in the course of goods deliveries from the seller to the buyer. The execution of the program instructions by the processor of the DLT node causes the processor to also control the DLT node such that in the course of logging the goods delivery in the DLT system the DLT node performs the following:
receiving at least one second update message from the further DLT node via an update of the second dataset using a second check result of checking one or more first sensor values of an outgoing goods log for consistency with the one or more physical properties of the goods to be delivered according to the shared dataset within predefined first tolerances, wherein the one or more first sensor values of the outgoing goods log are acquired by means of one or more first physical sensors assigned to the seller, wherein the checked first sensor values comprise at least the first sensor value quantifying the quantity of goods delivered,
performing a second update of the first dataset by means of the DLT node by using the second update message.

Further embodiments comprise a DLT node, wherein the program instructions providing the at least one smart contract comprise program instructions for validating the goods delivery. The execution of the program instructions by the processor of the DLT node causes the processor to also control the DLT node such that in the course of validating the goods delivery in the DLT system the DLT node performs the following:
receiving at least a third update message from the further DLT node via an update of the second dataset using a validation message, wherein the updating of the second dataset using the validation message comprises registering the validation message in the second dataset, wherein the updating of the second dataset using the validation message confirms a successful check of parameters of the validation message by the further DLT node, wherein the parameters comprise at least one quantity of goods to be validated, wherein the checking of the parameters comprises checking the quantity of goods to be validated for consistency with the first sensor value quantifying the delivered quantity of goods within a predefined second tolerance,
performing a third update of the first dataset by means of the DLT node by using the third update message, wherein the third update of the first dataset comprises registering the validation message in the first dataset.

For example, the DLT node is configured to carry out one or more of the aforementioned method steps of the DLT node assigned to the buyer according to exemplary embodiments of the method for computer-implemented monitoring of the goods delivery. For example, the DLT node is configured to carry out each of the aforementioned method steps of the DLT node assigned to the buyer according to exemplary embodiments of the method for computer-implemented monitoring of the goods delivery.

A “processor” here is a logic circuit used to execute program instructions. The logic circuit may be implemented on one or more discrete components, in particular on one or more chips. In particular, a “processor” means a microprocessor or a microprocessor system consisting of a plurality of processor cores and/or microprocessors.

A “program” or “program instructions” here means, without limitation, any type of computer program that includes machine-readable instructions for controlling a functionality of the computer.

A “memory” is understood here to mean both volatile and non-volatile memories, in particular electronic memories or digital storage media.

A “non-volatile memory” here means an electronic memory for the permanent storage of data. Non-volatile memory can be configured as non-variable memory, also known as read-only memory (ROM), or variable memory, also known as non-volatile memory (NVM). In particular, this can be an EEPROM, for example a flash EEPROM, briefly referred to as flash. A non-volatile memory is characterised by the fact that the data stored on it is retained even after the power supply has been switched off.

A “volatile memory” is understood here to mean an electronic memory for the temporary storage of data, which is characterised by the fact that stored data is lost after the power supply is switched off. In particular, this may refer to a volatile, direct access memory, also known as random access memory (RAM), or a volatile working memory of the processor.

A “protected memory area” here means an area of electronic memory to which access, i.e. read or write access, is only possible via a processor of the corresponding electronic device. According to embodiments, access from the processor coupled to the memory is only possible if a condition required for the purpose is met. This may be, for example, a cryptographic condition, in particular a successful authentication and/or a successful authorisation check of an access request.

A “communication interface” here means an interface via which data can be received and sent, wherein the communication interface can be configured in a contacting or contactless manner. The communication interface can be an internal interface or an external interface, which is connected to an associated device, for example, by means of a cable or wirelessly.

For example, communication can take place over a network. A “network” is understood here to mean any transmission medium with a connection for communication, in particular a local connection or a local network, in particular a local area network (LAN), a private network, in particular an intranet, or a virtual private network (VPN). For example, a computer system may have a standard radio interface for connecting to a WLAN. It may also be a public network, such as the internet. Depending on the embodiment, this connection can also be established via a mobile radio network.

A “mobile radio network” is understood here and in the following to mean a digital cellular mobile radio network, which can be set up according to a mobile communications standard such as GSM, UMTS, LTE, CDMA or another standard.

Further embodiments include a DLT node of an access-restricted DLT system for the computer-implemented monitoring of a goods delivery from a seller to a buyer. The DLT node is implemented on a DLT server of the DLT system and assigned to the seller. The DLT server comprises a processor and memory with program instructions. The program instructions provide at least one smart contract on the DLT node. In addition, the program instructions providing the at least one smart contract comprise program instructions for entering and checking delivery orders, order confirmations, and outgoing goods logs in the course of goods deliveries from the seller to the buyer, and for validating the goods delivery.

Execution of the program instructions by the processor causes the processor to control the DLT node in such a way that in the course of initialising the goods delivery in the DLT system the DLT node executes the following:
receiving at least one first dataset created by a further DLT node of the buyer from the further DLT node, the first dataset being a first part of a dataset shared between the DLT node and the further DLT node, wherein the first dataset comprises at least one or more physical properties of the goods to be delivered in accordance with a first specification of a delivery order, the physical characteristics of the first specification comprising at least one quantity of goods to be delivered,
creating a second dataset managed by the DLT node, wherein the second dataset is a second part of the shared dataset, and performing a first update of the second dataset by means of the DLT node based on the first dataset, wherein the first update comprises entering at least one or more of the physical properties of the first specification into the second dataset, the at least one or more entered physical properties of the first specification comprising the quantity of goods to be delivered,
receiving an order confirmation of the seller via a first network by means of the DLT node, wherein the order confirmation comprises a second specification of the one or more physical properties of the goods to be delivered,
checking the second specification for consistency with the first specification by using the at least one smart contract,
performing a second update of the second dataset by means of the second DLT node by using a first result of the check of the second specification,
transferring at least one third update message from the DLT node to the further DLT node in order to update the first dataset.

Further embodiments comprise a DLT node, wherein the program instructions providing the at least one smart contract comprise program instructions for entering and checking outgoing goods logs in the course of goods deliveries from the seller to the buyer. The execution of the program instructions by the processor of the DLT node causes the processor to also control the DLT node such that in the course of logging the goods delivery in the DLT system the DLT node performs the following:
receiving an outgoing goods log from the seller via the first network by means of the DLT node, wherein the outgoing goods log comprises one or more first sensor values for the one or more physical properties of the outgoing goods according to the second specification, which are detected by means of one or more first physical sensors assigned to the seller, the one or more first sensor values comprising at least one first sensor value which quantifies the delivered quantity of goods,
checking the one or more first sensor values of the outgoing goods log for consistency with the one or more physical properties of the goods to be delivered according to the shared dataset within predefined first tolerances by using the at least one smart contract, wherein the checked first sensor values comprise at least the first sensor value quantifying the quantity of goods delivered,
performing a third update of the second dataset by means of the DLT node by using a second result of checking the one or more first sensor values of the outgoing goods log,
transferring at least one second update message from the DLT node to the further DLT node in order to update the first dataset.

Further embodiments comprise a DLT node, wherein the program instructions providing the at least one smart contract comprise program instructions for validating the goods delivery. The execution of the program instructions by the processor of the DLT node causes the processor to also control the DLT node such that in the course of validating the goods delivery in the DLT system the DLT node performs the following:
checking parameters of a validation message for validating the goods delivery by means of the DLT node by using the at least one smart contract, wherein the parameters comprise at least one quantity of goods to be validated, the parameter checking comprising checking the quantity of goods to be validated for consistency with the first sensor value quantifying the quantity of goods delivered within a predefined second tolerance,
if the quantity of goods to be validated is consistent with the first sensor value quantifying the quantity of goods delivered within the predefined second tolerance, performing a fourth update of the second dataset by the DLT node, wherein the fourth update comprises registering the validation message in the second dataset by means of the DLT node by using the at least one smart contract,
transferring at least one third update message from the DLT node to the further DLT node in order to update the first dataset.

For example, the DLT node is configured to carry out one or more of the aforementioned method steps of the DLT node assigned to the seller according to exemplary embodiments of the method for computer-implemented monitoring of the goods delivery. For example, the DLT node is configured to carry out each of the aforementioned method steps of the DLT node assigned to the seller according to exemplary embodiments of the method for computer-implemented monitoring of the goods delivery.

Further embodiments comprise a DLT system for the computer-implemented monitoring of a goods delivery from a seller to a buyer, which comprises a first DLT node assigned to the buyer and a second DLT node assigned to the seller. The first DLT node and the second DLT node are provided by one or more DLT servers of the DLT system. The DLT system provides at least one smart contract. The at least one smart contract comprises program instructions for entering and checking delivery orders and order confirmations.

The DLT system is configured to perform an initialisation of the goods delivery in the DLT system. The initialising comprises:
receiving a delivery order of the buyer via a first network by means of the first DLT node relating to goods to be delivered from the seller to the buyer, wherein the delivery order defines one or more physical properties of the goods to be delivered as a first specification, the physical properties of the first specification comprising at least one quantity of goods to be delivered,
creating a first dataset managed by the first DLT node and entering at least the one or more physical properties of the delivery order into the first dataset by means of the first DLT node by using the at least one smart contract, wherein the first dataset is a first part of a dataset shared between the first DLT node and the second DLT node,
transferring at least the first dataset from the first DLT node to the second DLT node,
creating a second dataset managed by the second DLT node, wherein the second dataset is a second part of the shared dataset, and performing a first update of the second dataset by means of the second DLT node based on the first dataset, wherein the first update comprises entering at least one or more of the physical properties of the first specification into the second dataset, the at least one or more entered physical properties of the first specification comprising the quantity of goods to be delivered,
receiving an order confirmation of the seller via the first network by means of the second DLT node, wherein the order confirmation comprises a second specification of the one or more physical properties of the goods to be delivered,
checking the second specification for consistency with the first specification by using the at least one smart contract,
performing a second update of the second dataset by means of the second DLT node by using a first result of the check of the second specification,
transferring at least one first update message from the second DLT node to the first DLT node,
performing a first update of the first dataset by means of the first DLT node by using the first update message.

Further embodiments comprise a DLT system, which is further configured to perform a logging of the goods delivery in the DLT system. The at least one smart contract comprises program instructions for entering and checking outgoing goods logs in the course of goods deliveries from the seller to the buyer. The logging comprises:
receiving an outgoing goods log from the seller via the first network by means of the second DLT node, wherein the outgoing goods log comprises one or more first sensor values for the one or more physical properties of the outgoing goods according to the second specification, which are detected by means of one or more first physical sensors assigned to the seller, the one or more first sensor values comprising at least one first sensor value which quantifies the delivered quantity of goods,
checking the one or more first sensor values of the outgoing goods log for compliance with the one or more physical properties of the goods to be delivered according to the shared dataset within predefined first tolerances by using the at least one smart contract, wherein the checked first sensor values comprise at least the first sensor value quantifying the quantity of goods delivered,
performing a third update of the second dataset by means of the second DLT node by using a second result of checking the one or more first sensor values of the outgoing goods log,
transmitting at least a second update message from the second DLT node to the first DLT node,
performing a second update of the first dataset by means of the first DLT node by using the second update message.

Further embodiments comprise a DLT system, which is further configured to perform a validation of the goods delivery in the DLT system. The at least one smart contract contains program instructions for validating the goods delivery. The validation comprises:
checking parameters of a validation message for validating the goods delivery by means of the second DLT node by using the at least one smart contract, wherein the parameters comprise at least one quantity of goods to be validated, the parameter checking comprising checking the quantity of goods to be validated for consistency with the first sensor value quantifying the quantity of goods delivered within a predefined second tolerance,
if the quantity of goods to be validated is consistent with the first sensor value quantifying the quantity of goods delivered within the predefined second tolerance, performing a fourth update of the second dataset by means of the DLT node, wherein the fourth update comprises registering the validation message in the second dataset by means of the second DLT node by using the at least one smart contract,
transferring at least a third update message from the second DLT node to the first DLT node,
performing a third update of the first dataset by means of the first DLT node by using the third update message, wherein the third update of the first dataset comprises registering the validation message in the first dataset.

For example, the DLT system is configured to implement one or more of the aforementioned exemplary embodiments of the method for computer-implemented monitoring of the goods delivery. For example, the DLT system is configured to carry out each of the aforementioned exemplary embodiments of the method for computer-implemented monitoring of the goods delivery.

Further embodiments comprise a computer program for monitoring a goods delivery from a seller to a buyer using an access-restricted DLT system, which comprises a first DLT node assigned to the buyer and a second DLT node assigned to the seller. The computer program provides at least one smart contract. The at least one smart contract comprises program instructions for entering and checking delivery orders and order confirmations.

The computer program comprises program instructions for initialising the goods delivery in the DLT system. The initialising comprises:
receiving a delivery order of the buyer via a first network by means of the first DLT node relating to goods to be delivered from the seller to the buyer, wherein the delivery order defines one or more physical properties of the goods to be delivered as a first specification, the physical properties of the first specification comprising at least one quantity of goods to be delivered,
creating a first dataset managed by the first DLT node and entering at least the one or more physical properties of the delivery order into the first dataset by means of the first DLT node by using the at least one smart contract, wherein the first dataset is a first part of a dataset shared between the first DLT node and the second DLT node,
transferring at least the first dataset from the first DLT node to the second DLT node,
creating a second dataset managed by the second DLT node, wherein the second dataset is a second part of the shared dataset, and performing a first update of the second dataset by means of the second DLT node based on the first dataset, wherein the first update comprises entering at least one or more of the physical properties of the first specification into the second dataset, the at least one or more entered physical properties of the first specification comprising the quantity of goods to be delivered,
receiving an order confirmation of the seller via the first network by means of the second DLT node, wherein the order confirmation comprises a second specification of the one or more physical properties of the goods to be delivered,
checking the second specification for consistency with the first specification by using the at least one smart contract,
performing a second update of the second dataset by means of the second DLT node by using a first result of the check of the second specification,
transferring at least one first update message from the second DLT node to the first DLT node,
performing a first update of the first dataset by means of the first DLT node by using the first update message.

Further embodiments comprise a computer program, which further comprises program instruction for logging the goods delivery in the DLT system. The at least one smart contract comprises program instructions for entering and checking outgoing goods logs in the course of goods deliveries from the seller to the buyer. The logging comprises:
receiving an outgoing goods log from the seller via the first network by means of the second DLT node, wherein the outgoing goods log comprises one or more first sensor values for the one or more physical properties of the outgoing goods according to the second specification, which are detected by means of one or more of the first physical sensors assigned to the seller, wherein the one or more first sensor values comprise at least one first sensor value which quantifies the delivered quantity of goods,
checking the one or more first sensor values of the outgoing goods log for consistency with the one or more physical properties of the goods to be delivered according to the shared dataset within predefined first tolerances by using the at least one smart contract, wherein the checked first sensor values comprise at least the first sensor value quantifying the quantity of goods delivered,
performing a third update of the second dataset by means of the second DLT node by using a second result of checking the one or more first sensor values of the outgoing goods log,
transmitting at least a second update message from the second DLT node to the first DLT node,
performing a second update of the first dataset by means of the first DLT node by using the second update message.

Further embodiments comprise a computer program, which further comprises program instructions for validating the goods delivery in the DLT system. The at least one smart contract comprises program instructions for validating the goods delivery. The validation comprises:
checking parameters of a validation message for validating the goods delivery by means of the second DLT node by using the at least one smart contract, wherein the parameters comprise at least one quantity of goods to be validated, the parameter checking comprising checking the quantity of goods to be validated for compliance with the first sensor value quantifying the quantity of goods delivered within a predefined second tolerance,
if the quantity of goods to be validated is consistent with the first sensor value quantifying the quantity of goods delivered within the predefined second tolerance, performing a fourth update of the second dataset by means of the second DLT node, wherein the fourth update comprises registering the validation message in the second dataset by means of the second DLT node by using the at least one smart contract,
transferring at least one third update message from the second DLT node to the first DLT node,
performing a third update of the first dataset by means of the first DLT node by using the third update message, wherein the third update of the first dataset comprises registering the validation message in the first dataset.

For example, the computer program is configured to carry out one or more of the aforementioned exemplary embodiments of the method for computer-implemented monitoring of the goods delivery. For example, the computer program is configured to carry out each of the aforementioned exemplary embodiments of the method for computer-implemented monitoring of the goods delivery.

In further embodiments, a computer-readable data carrier or a computer-readable medium is defined, which stores program instructions on it, which, when they are executed by at least one processor (or at least one electronic device), configure the at least one processor (or at least one electronic device), to carry out a method according to any one of the preceding embodiments. In this case, the program instructions can correspond to the program instructions of the computer program according to embodiments. It should be understood that there may also be several data carriers or media provided, which may be installed on individual processors or electronic devices for carrying out the methods provided.

Below, embodiments of the invention are described in more detail with reference to the drawings. In the drawings:

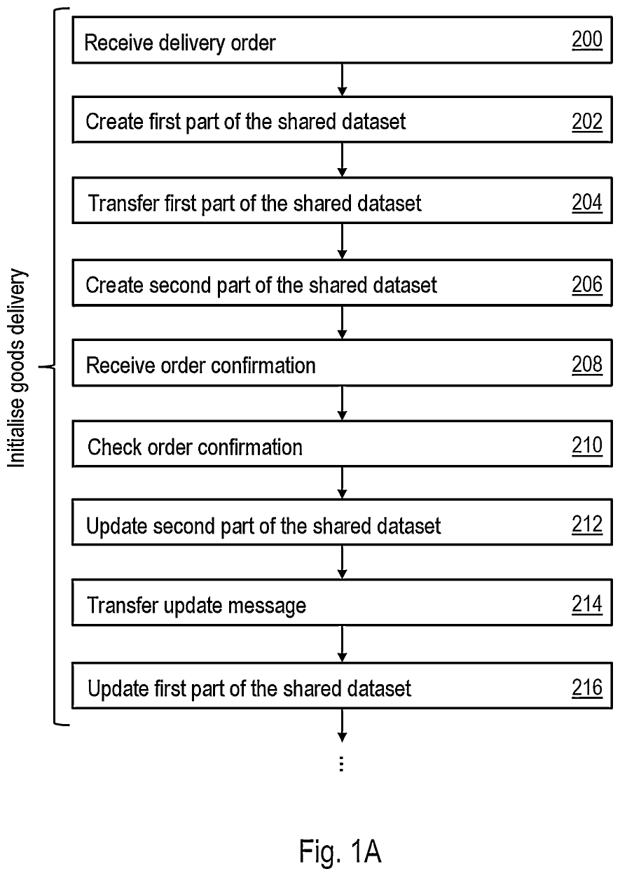

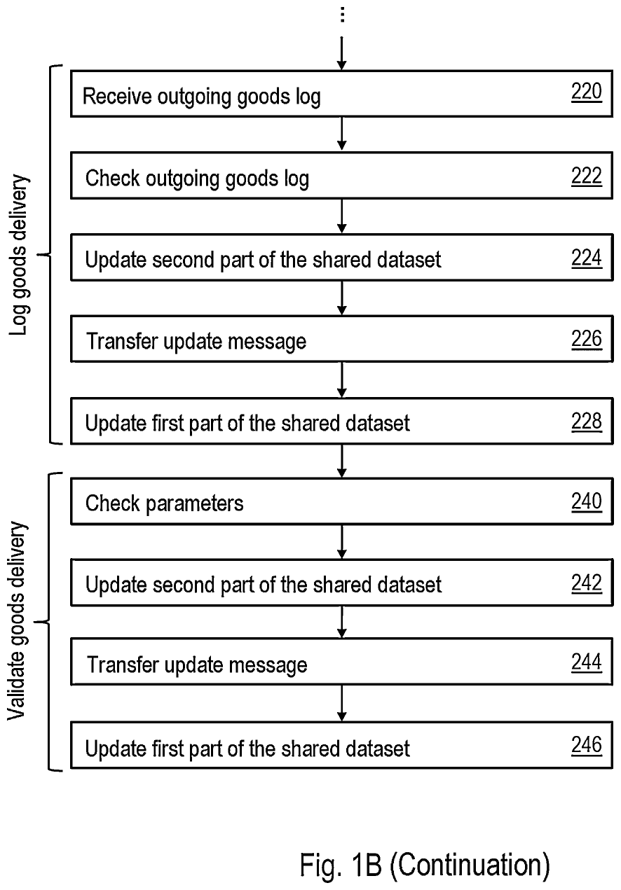

FIG. 1A shows a schematic flow diagram of a first part of an exemplary method for monitoring a goods delivery,

FIG. 1B shows a schematic flow diagram of a second part of an exemplary method for monitoring a goods delivery,

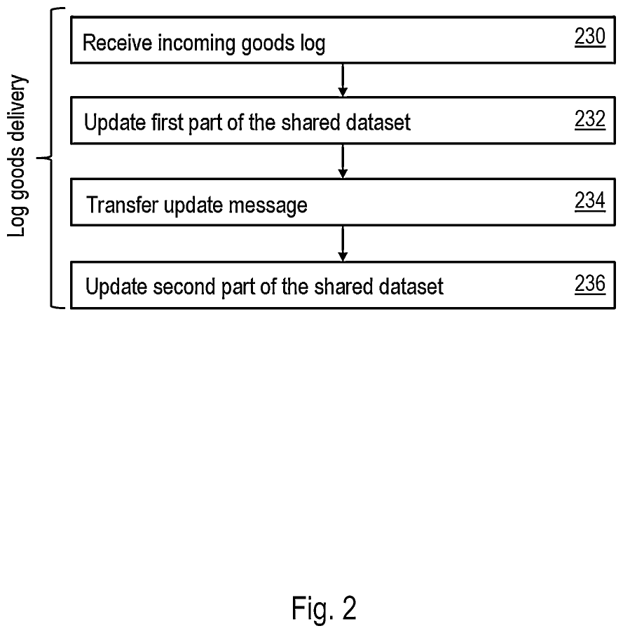

FIG. 2 shows a schematic flow diagram of a logging of a goods delivery using an incoming goods log,

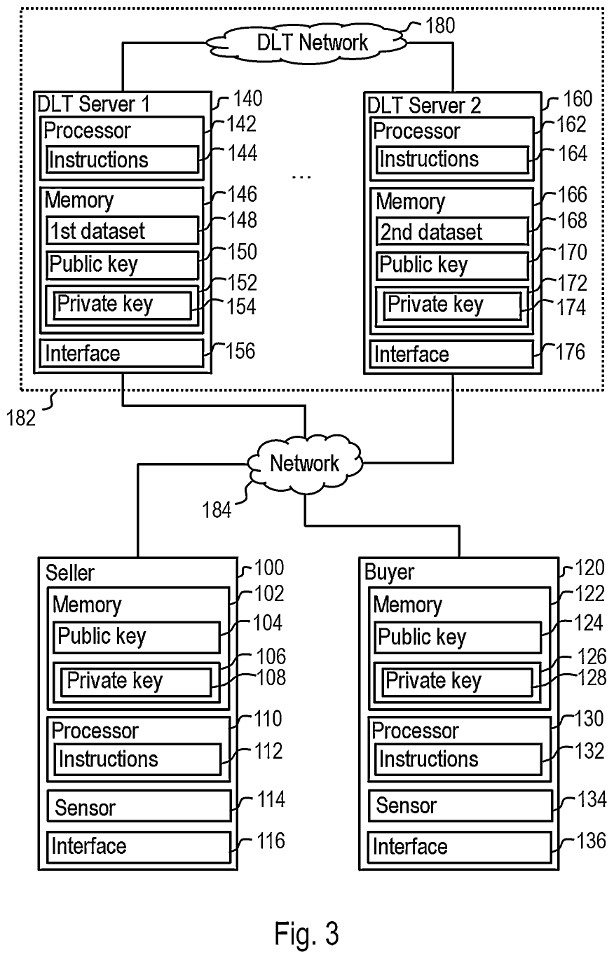

FIG. 3 shows a schematic block diagram of an exemplary DLT system for computer-implemented monitoring of a goods delivery,

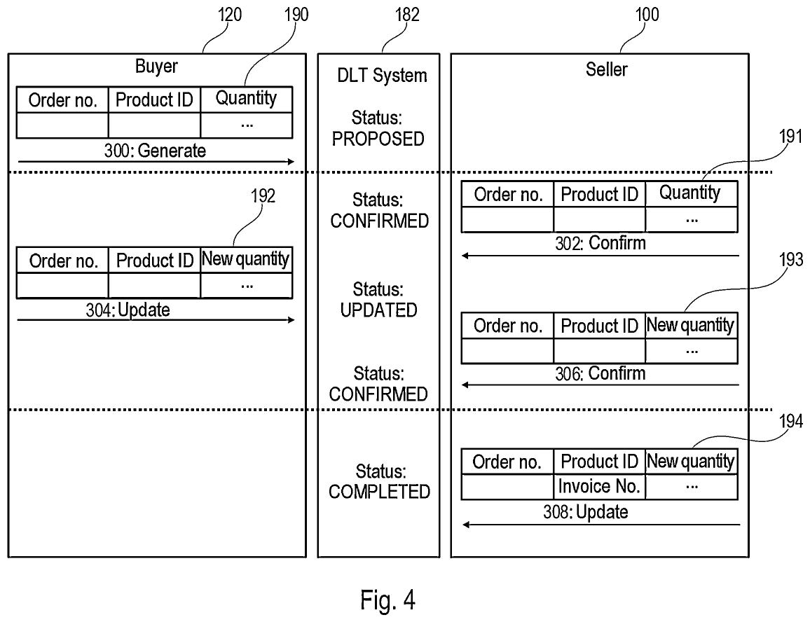

FIG. 4 shows a schematic flow diagram of an exemplary method for computer-implemented monitoring of a goods delivery,

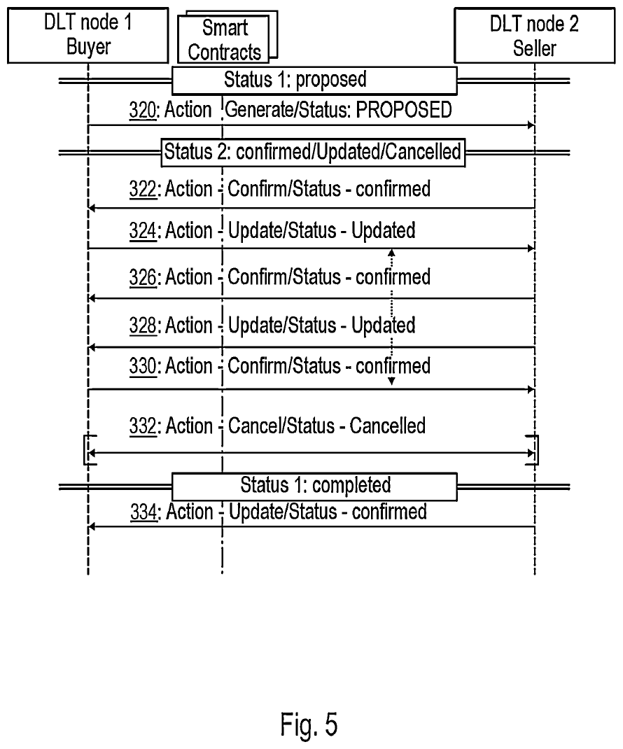

FIG. 5 shows a schematic flow diagram of an exemplary method for computer-implemented monitoring of a goods delivery,

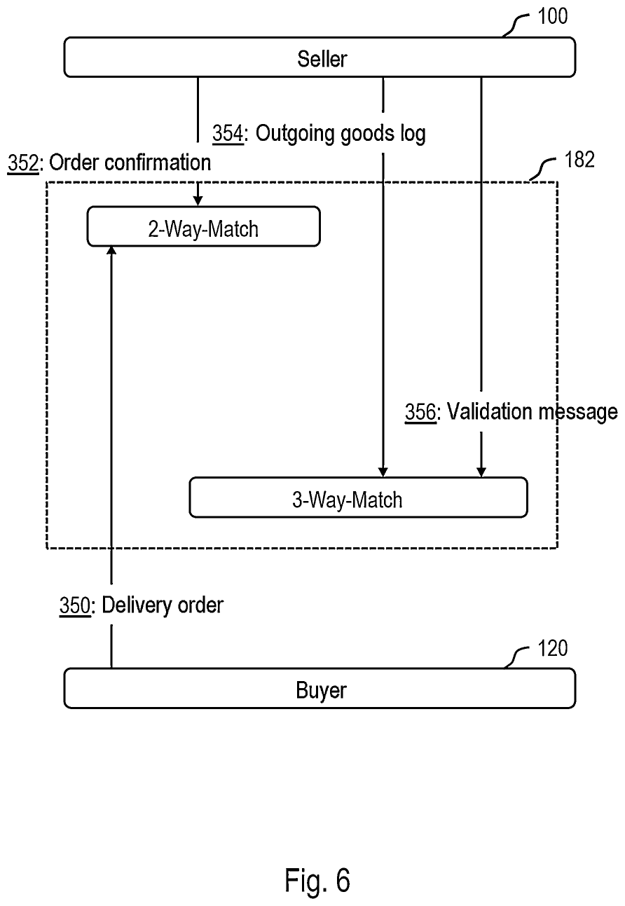

FIG. 6 shows a schematic flow diagram of an exemplary method for computer-implemented monitoring of a goods delivery,

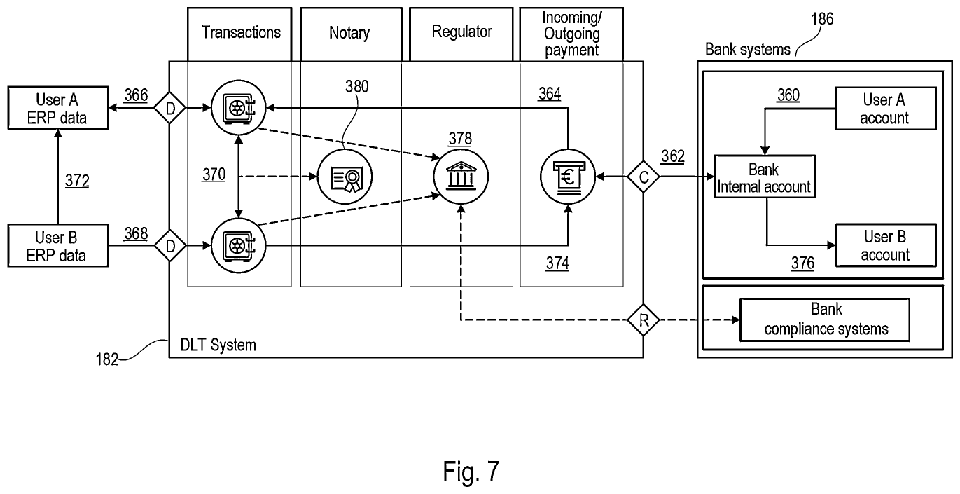

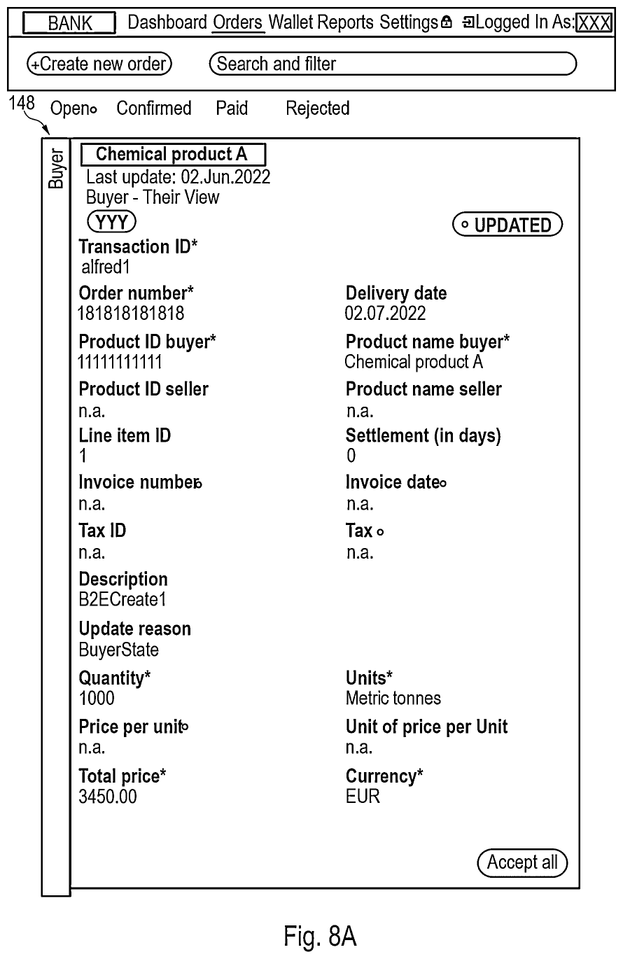

FIG. 7 shows a schematic block diagram of an exemplary system for computer-implemented monitoring of a goods delivery including electronic payment transactions,

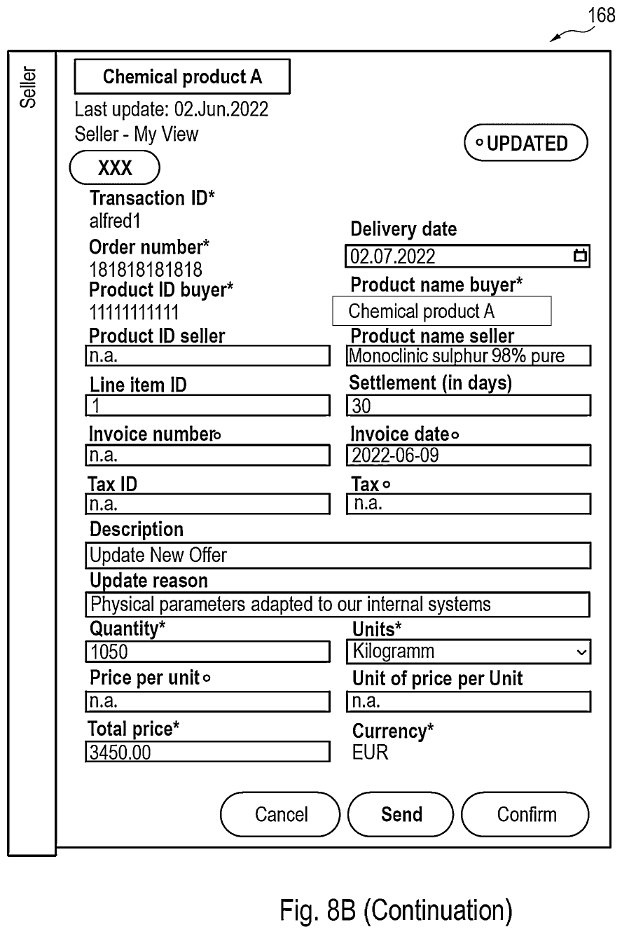

FIG. 8A shows a first part of a first exemplary graphical user interface,

FIG. 8B shows a second part of a first exemplary graphical user interface, and

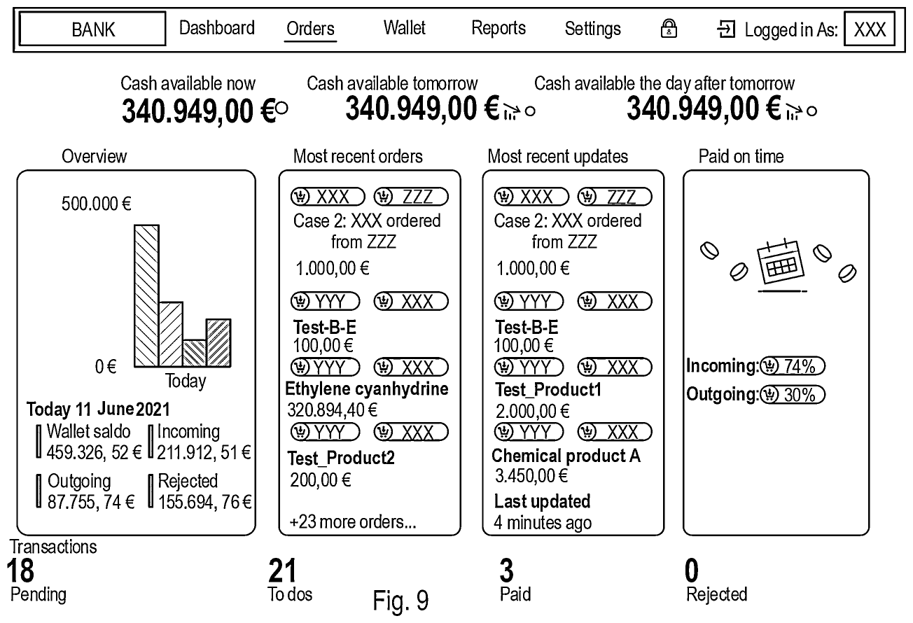

FIG. 9 shows a second exemplary graphical user interface.

Elements of the following embodiments that correspond to one another are identified with the same reference signs.

FIGS. 1A and 1B show an exemplary method for computer-implemented monitoring of a goods delivery from a seller to a buyer by using an access-restricted DLT system. The DLT system comprises a first DLT node assigned to the buyer and a second DLT node assigned to the seller. In addition, the DLT system provides at least one smart contract comprising program instructions for entering and checking delivery orders, order confirmations, and/or outgoing goods logs in the course of goods deliveries from the seller to the buyer, and/or for validating the goods deliveries.

The method comprises initialising the goods delivery in the DLT system, logging the goods delivery in the DLT system, and validating the goods delivery in the DLT system. The initialisation is shown in FIG. 1A, the logging and validation in FIG. 1B.

In block 200, a delivery order from the buyer is received by the first DLT node via a first network. The delivery order is a delivery order for goods to be delivered by the seller to the buyer. The delivery order defines one or more physical properties of the goods to be delivered as a first specification, which comprises at least one quantity of goods to be delivered.

In block 202, for example as a result of a receipt of the delivery order, the first dataset managed by the first DLT node is created. This first dataset is a first partial dataset of a shared dataset. The corresponding shared dataset is a dataset that comprises the first partial dataset on the first DLT node and a second partial dataset on the second DLT node. Only the first DLT node and thus the buyer has authorisation to edit the first partial dataset, i.e. write authorisation, whereas for the second dataset only the second DLT node and thus the seller has editing authorisation, i.e. write authorisation. In addition, as a result of the access restriction of the DLT system, for example, only the buyer via the first DLT node has read authorisation for reading the first partial dataset and only the seller has read authorisation for reading the second partial dataset via the second DLT node.

In the course of creating the first dataset, at least the one or more physical properties of the delivery order are also entered into the first dataset by the first DLT node using the at least one smart contract. These one or more physical properties entered include at least a quantity of goods to be delivered.

In block 204, this first dataset or the one or more physical properties entered in the first dataset according to the first specification of the delivery order are transferred to the second DLT node of the seller. In block 206, the second DLT node creates the second partial dataset of the shared dataset, into which one or more physical properties according to the first specification are entered. In this case the one or more entered physical properties according to the first specification include at least a quantity of goods to be delivered. As a result, both partial datasets of the shared dataset thus include, for example, identical data, provided that there is agreement about the individual parameters of the specification between the seller and buyer, as described below.

In block 208, the second DLT node receives an order confirmation from the seller via the first network, comprising a second specification of the one or more physical properties of the goods to be delivered. Upon receipt of an order confirmation, in block 210 the second specification is checked for consistency with the first specification by means of the second DLT node using the at least one smart contract, and in block 212 the second dataset is updated using the result of the second specification check.

If the second specification is consistent with the first specification, the updating of the second dataset using the test result comprises, for example, entering a confirmation of the first specification. For example, the updating of the second dataset using the test result comprises entering the second specification into the second dataset in addition to the first specification.

If the second specification differs from the first specification, updating the second dataset using the test result comprises, for example, replacing or updating the physical properties according to the first specification with the diverging physical properties according to the second specification. For example, in the course of updating the second dataset, the diverging physical properties according to the second specification are entered into the second dataset in addition to the first specification. For example, the second specification is entered into the second dataset in addition to the first specification.

In addition, a first update message is transferred from the second DLT node to the first DLT node in block 214. For example, the first update message indicates whether the second specification is consistent with the first specification. For example, if one or more physical properties according to the second specification differ from the first specification, the first update message identifies the one or more diverging physical properties according to the second specification. For example, the first update message comprises the entire second specification or a copy of the second specification.

In block 216, the first DLT node updates the first dataset, i.e. the first partial dataset of the shared dataset, using the first update message. If the second specification is consistent with the first specification, updating the first dataset using the first update message comprises, for example, entering a confirmation of the first specification. For example, updating the first dataset using the first update message comprises entering the second specification into the first dataset in addition to the first specification.

If the second specification differs from the first specification, updating the first dataset using the first update message comprises, for example, replacing or updating the physical properties according to the first specification with the differing physical properties according to the second specification. For example, in the course of updating the first dataset, the diverging physical properties according to the second specification are entered into the second dataset in addition to the first specification. For example, the second specification is entered into the second dataset in addition to the first specification.

If the second specification differs from the first specification, for example, a handshake is performed between the first DLT node and the second DLT node to match the first specification and the second specification, so that the first and second specifications resulting from the match are identical.

If the second specification is consistent with the first specification, for example, a confirmation message is sent from the second DLT node to the seller over the network. For example, the second specification is consistent with the first specification when an identity is present. For example, the second specification is consistent with the first specification if there are no deviations that exceed a predefined tolerance range. For example, the confirmation message indicates to the seller that an agreement has been reached on the corresponding goods delivery between buyer and seller. In addition, the confirmation message includes, for example, the specification of the corresponding goods delivery. For example, the corresponding confirmation message serves as a trigger to initiate the corresponding goods delivery.

The method of FIG. 1A is preferably continued in FIG. 1B with a logging of the goods delivery in the DLT system. If the physical goods delivery is carried out, i.e. the goods to be delivered leave a warehouse of the seller, an outgoing goods log is created. The corresponding outgoing goods log comprises one or more sensor values for the one or more physical properties of the outgoing goods according to the second specification, which are detected by means of one or more physical sensors assigned to the seller. The outgoing goods log therefore specifies for one or more physical properties, for which target values are specified in the second specification, measured values detected by sensors in each case, which reflect the actual status of the outgoing goods with regard to the corresponding physical properties. The corresponding sensor values include at least one sensor value which quantifies the delivered, i.e. outgoing, quantity of goods.

In block 220, the second DLT node of the seller receives the outgoing goods log from the seller via the first network and in block 222 checks the one or more first sensor values of the outgoing goods log for consistency with the one or more physical properties of the goods to be delivered. In this process, it is checked whether the one or more sensor values of the incoming goods log are consistent with one or more physical properties according to the shared dataset within predefined tolerances. If no such consistency is present, for example, a warning message is sent to the seller and/or the buyer. Such a warning message can, for example, trigger a re-delivery by the seller if the delivery quantity is too little. On the part of the buyer, such a warning message can trigger, for example, a review of the deviating physical properties on the arrival of the goods. For example, such a warning message may require confirmation of the deviating physical properties on the part of the buyer for a successful final validation of the goods delivery.

In block 224, the second dataset is updated by the second DLT node by using the result of the check of the one or more first sensor values of the outgoing goods log. For example, the update comprises entering the outgoing goods log and/or one or more of the sensor values indicated by the outgoing goods log. For example, all sensor values specified by the outgoing goods log are entered. For example, only those sensor values are entered which deviate from the values entered in the second dataset for the physical properties of the goods to be delivered. For example, for sensor values of the outgoing goods log which match the values entered in the second dataset for the physical properties of the goods to be delivered, only a confirmation to the effect that the corresponding values for the physical properties match the acquired sensor values is entered into the second dataset.

In block 226 a second update message is sent from the second DLT node to the first DLT node, For example, the second update message includes the outgoing goods log and/or one or more of the sensor values indicated by the outgoing goods log. For example, the second update message includes all the sensor values indicated by the outgoing goods log. For example, the second update message includes only those sensor values which deviate from the values entered in the second dataset for the physical properties of the goods to be delivered. For example, for sensor values of the outgoing goods log which match the values entered in the second dataset for the physical properties of the goods to be delivered, the second update message includes only a confirmation to the effect that the corresponding values for the physical properties according to the shared dataset match the detected sensor values.

In block 228, the first DLT node updates the first dataset, i.e. the first partial dataset of the shared dataset, using the second update message. For example, the update comprises entering the outgoing goods log and/or one or more of the sensor values indicated by the outgoing goods log. For example, all sensor values specified by the outgoing goods log are entered. For example, only those sensor values are entered which deviate from the values entered in the first dataset for the physical properties of the goods to be delivered. For example, for sensor values of the outgoing goods log which match the values for the physical properties of the goods to be delivered entered in the first dataset, only a confirmation to the effect that the corresponding values for the physical properties match the acquired sensor values is entered into the first dataset.

Finally, a validation of the goods delivery in the DLT system is performed. For this purpose, in block 240, parameters of a validation message for validating the goods delivery are checked by the second DLT node. The checked parameters of the validation message include at least one indication of the quantity of delivered goods to be validated. Checking the corresponding parameters involves checking the quantity of goods to be validated for consistency with the sensor value quantifying the delivered quantity according to the outgoing goods log within a predefined tolerance. If the quantity of goods to be validated is consistent with the sensor value quantifying the delivered quantity of goods within the predefined tolerance, in block 242 the second dataset is updated by the second DLT node using the validation message. The updating involves registering the validation message in the second dataset by means of the second DLT node. For example, in the course of the registration, an identifier of the validation message is entered into the second dataset. For example, a check value, such as a hash value, of the validation message is entered into the second dataset. For example, one or more parameters of the validation message are entered into the second dataset. For example, the validation message is entered into the second dataset.

For example, the validation is triggered by receipt of the validation message or by generation of the validation message. For example, generation of the validation message is triggered by reception of a confirmation of receipt of the delivered goods from the buyer. For example, a receipt confirmation is received in the form of an incoming goods log.

In block 244, the second DLT node sends a third update message to the first DLT node. For example, the third update message includes the validation message data entered into the second dataset during the update. For example, the third update message includes the complete updated second dataset. For example, the third update message includes the validation message.

In block 246, the first DLT node updates the first dataset using the third update message of the second dataset. Updating the first dataset involves registering the validation message in the first dataset. For example, in the course of the registration, an identifier of the validation message is entered into the first dataset. For example, a check value, such as a hash value, of the validation message is entered into the first dataset. For example, one or more parameters of the validation message are entered into the first dataset. For example, the validation message is entered into the first dataset.

FIG. 2 shows an exemplary logging of a goods delivery using a goods receipt log. For this purpose, the program instructions included in the at least one smart contract are further configured for entering and checking incoming goods logs in the course of goods deliveries from the seller to the buyer.

Once the physical goods delivery is received by the buyer, i.e. the goods to be delivered reach a warehouse of the buyer, an incoming goods log is created. The corresponding incoming goods log comprises one or more sensor values for the one or more physical properties of the incoming goods according to the first specification, which are acquired by means of one or more physical sensors assigned to the buyer. The incoming goods log therefore specifies for one or more physical properties, for which target values are specified in the first specification, measured values acquired by sensors in each case, which reflect the actual status of the incoming goods with regard to the corresponding physical properties. The corresponding sensor values include at least one sensor value which quantifies the delivered, i.e. incoming, quantity of goods.

The logging of the goods delivery in the DLT system according to FIG. 1B comprises block 230 in this case. In block 230, the first DLT node receives an incoming goods log from the buyer via the first network. In addition, the first DLT node checks the one or more second sensor values of the incoming goods log for consistency with the one or more physical properties of the goods to be delivered. In this process, it is checked whether the one or more sensor values of the incoming goods log are consistent with one or more physical properties according to the shared dataset within predefined tolerances. If no such consistency is present, for example, a warning message is sent to the buyer and/or the seller. Such a warning message can, for example, trigger a re-delivery by the seller if the delivery quantity is too little. On the part of the buyer, for example, such a warning message may require confirmation of the deviating physical properties by the buyer for a successful final validation of the goods delivery.

In block 232, the first dataset is updated by the first DLT node by using the result of the check of the one or more first sensor values of the incoming goods log. For example, the update comprises entering the incoming goods log and/or one or more of the sensor values indicated by the incoming goods log. For example, all sensor values specified by the incoming goods log are entered. For example, only those sensor values are entered which deviate from the values entered in the first dataset for the physical properties of the goods to be delivered. For example, for sensor values of the incoming goods log which match the values for the physical properties of the goods to be delivered entered in the first dataset, only a confirmation to the effect that the corresponding values for the physical properties match the acquired sensor values is entered into the second dataset.

In addition, in block 234 a fourth update message is transferred from the first DLT node to the second DLT node. For example, the fourth update message includes the incoming goods log and/or one or more of the sensor values specified by the incoming goods log. For example, the fourth update message includes all the sensor values specified by the incoming goods log. For example, the fourth update message includes only those sensor values which deviate from the values entered in the first dataset for the physical properties of the goods to be delivered. For example, for sensor values of the incoming goods log which match the values entered in the first dataset for the physical properties of the goods to be delivered, the fourth update message includes only a confirmation to the effect that the corresponding values for the physical properties according to the shared dataset match the detected sensor values.

Finally, in block 236 the second DLT node updates the second dataset, i.e. the second partial dataset of the shared dataset, by using the fourth update message. For example, the update comprises entering the incoming goods log and/or one or more of the sensor values indicated by the incoming goods log. For example, all sensor values specified by the incoming goods log are entered. For example, only those sensor values are entered which deviate from the values entered in the second dataset for the physical properties of the goods to be delivered. For example, for sensor values of the incoming goods log which match the values for the physical properties of the goods to be delivered entered in the second dataset, only a confirmation to the effect that the corresponding values for the physical properties match the acquired sensor values is entered into the second dataset.

FIG. 3 shows an exemplary DLT system 182 for the computer-implemented monitoring of a goods delivery from a seller to a buyer. The DLT System 182 comprises a plurality of DLT Servers 140, 160. The DLT system 182 comprises a first DLT node assigned to the buyer, which is provided by a first DLT server 140 of the DLT system 182. In addition, the DLT system 182 comprises a second DLT node assigned to the seller, which is provided by a second DLT server 160 of the DLT system 182. However, it should be clear that the DLT nodes can also be deployed on a single DLT server, e.g. DLT Server 140 or DLT Server 160, and the present description is not limited to deploying DLT nodes on separate DLT servers.

The first DLT server 140 comprises a processor 142, which is configured to execute program instructions 144. The program instructions 144 implement the first DLT node of the buyer on the first DLT server 140. The program instructions 144 implement one or more smart contracts for execution by the first DLT node on the first DLT server 140. The program instructions 144, which implement the one or more smart contracts, include program instructions for executing a method, for example the method according to FIGS. 1A and/or 1B or parts thereof, for the computer-implemented monitoring of a goods delivery from a seller to a buyer using the access-restricted DLT system 182. The method may comprise entering and checking delivery orders, order confirmations and/or outgoing goods logs in the course of goods deliveries from the seller to the buyer and/or validating the goods deliveries, in any combination.

In addition, the first DLT server 140 has a memory 146 and a communication interface 156. The communication interface 156 is configured so that the first DLT server 140 can communicate via a network 184 with a computer system 120 of the buyer, for example. The network 184 is, for example, the Internet. Further, the communication interface 156 is designed, for example, for communication via a DLT network 180 with other DLT servers of the DLT system, for example with the second DLT server 160, on which the DLT node of the seller is implemented. For example, the DLT network 180 may be part of the network 184. For example, the DLT Network 180 is a stand-alone network, such as an intranet.

For example, a protected memory area 152 of the memory 146 of the first DLT server 140 stores a private cryptographic key 154 of an asymmetric key pair assigned to the first DLT node of the buyer. For example, this private cryptographic key 154 is used as a signature key to create electronic signatures for the first DLT node. Corresponding signatures can be checked with a public cryptographic key 150 of the corresponding asymmetric key pair. For example, the public cryptographic key 150 is provided as part of a certificate. The first DLT node of the buyer makes this public cryptographic key 150, or the certificate comprising the public cryptographic key 150, available to other DLT nodes, such as the second DLT node of the seller, as a signature verification key.

The first DLT server 160 comprises a processor 162, which is configured to execute program instructions 164. The program instructions 164 implement the second DLT node of the buyer on the second DLT server 160. The program instructions 164 also implement one or more smart contracts on the second DLT server 160 for execution by the second DLT node. The smart contracts on the second DLT node can correspond to the smart contracts on the first DLT node, ensuring that both DLT nodes define a corresponding behaviour. The program instructions 164, which implement the one or more smart contracts, include program instructions for executing a method, for example the method according to FIGS. 1A and/or 1B or parts thereof, for the computer-implemented monitoring of a goods delivery from a seller to a buyer using the access-restricted DLT system 182. The method may comprise entering and checking delivery orders, order confirmations and/or outgoing goods logs in the course of goods deliveries from the seller to the buyer and/or validating the goods deliveries, in any combination.

In addition, the second DLT server 160 has a memory 166 and a communication interface 176. The communication interface 176 is configured so that the first DLT server 160 can communicate via the network 184 with a computer system 100 of the seller, for example. Further, the communication interface 176 is designed, for example, for communication via the DLT network 180 with other DLT servers of the DLT system, for example with the first DLT server 140, on which the DLT node of the seller is implemented.

For example, in a protected memory area 172 of the memory 166 of the second DLT server 160, a private cryptographic key 174 of an asymmetric key pair assigned to the second DLT node of the seller is stored. For example, this private cryptographic key 174 is used as a signature key to create electronic signatures for the second DLT node. Corresponding signatures can be checked with a public cryptographic key 170 of the corresponding asymmetric key pair. For example, the public cryptographic key 170 is provided as part of a certificate. The first DLT node of the seller makes this public cryptographic key 170, or the certificate comprising the public cryptographic key 170, available to other DLT nodes, such as the first DLT node of the buyer, as a signature verification key.

In the course of initialising the goods delivery, a shared dataset is created on the two DLT nodes, which comprises a first partial dataset 148 on the first DLT node and a second partial dataset 168 on the second DLT node. The first partial dataset 148 is stored in the memory 146 of the first DLT server 140. The second partial dataset 168 is stored in the memory 166 of the second DLT server 160.

Only the first DLT node and thus the buyer has authorisation to edit the first partial dataset, i.e. write authorisation, whereas for the second dataset only the second DLT node and thus the seller has editing authorisation, i.e. write authorisation. In addition, as a result of the access restriction of the DLT system, for example, it is also only the buyer, via first DLT node implemented on the first DLT server 140, who has read authorisation for reading the first partial dataset and only the seller has read authorisation for reading the second partial dataset via the second DLT node implemented on the second DLT server 160.

Executing the program instructions 144 by means of the processor 142 causes the processor 142 to control the first DLT server 140 such that the first DLT node implemented on the first DLT server 140 receives a delivery order from the buyer relating to goods to be delivered from the seller to the buyer in the course of initialising the goods delivery in the DLT system 182. For example, the first DLT node receives the delivery order from a computer system 120 of the buyer via the network 184. The delivery order defines one or more physical properties of the goods to be delivered as a first specification. The physical properties of the first specification include at least one quantity of goods to be delivered.

The computer system 120 of the buyer comprises a processor 130, which is configured to execute program instructions 132. The program instructions 132 cause the computer system 120 to communicate, for example, via the network 184 with the first DLT server 140 or the first DLT node of the buyer implemented on the first DLT server 140. For example, the computer system 120 of the buyer sends the delivery order to the first DLT node. For this purpose, the computer system 120 comprises a communication interface 136 for communication over the network 184.

In addition, the computer system 120 has a memory 122. For example, a protected memory area 126 of the memory 122 of the computer system 120 stores a private cryptographic key 128 of an asymmetric key pair assigned to the buyer. For example, this private cryptographic key 128 is used as a signature key to create electronic signatures for the buyer. Corresponding signatures can be checked with a public cryptographic key 124 of the corresponding asymmetric key pair. For example, the public cryptographic key 124 is provided as part of a certificate. The computer system 120 makes this public cryptographic key 124, or the certificate comprising the public cryptographic key 124, available to other parties involved, such as the first DLT node of the buyer implemented on the first DLT server, as a signature verification key.

The first node creates the dataset 148 managed by the DLT node and enters at least the one or more physical properties of the delivery order into the first dataset 148 using the at least one smart contract.

In addition, at least the first dataset 148 is sent from the first DLT node or the DLT server 140 via the DLT network 180 to the second DLT node implemented on the second DLT server 160. The first DLT node receives at least one first update message, via the DLT network 180 from the second DLT node or second DLT server 160, about an update of the second dataset 168 on the second DLT server. The update was carried out using a first check result of checking a second specification of the one or more physical properties of the goods to be delivered in accordance with an order confirmation of the seller for consistency with the first specification in accordance with the delivery order of the buyer. The first dataset 148 is then updated by the first DLT node using the first update message.

The corresponding order confirmation is received by the second DLT server 160, for example via the network 184, from a computer system 100 of the seller. The computer system 160 of the buyer comprises a processor 110, which is configured to execute program instructions 112. The program instructions 112 cause the computer system 100 to communicate, for example via the network 184, with the second DLT server 160 or the second DLT node of the seller implemented on the second DLT server 160. For example, the computer system 100 of the seller sends the order confirmation to the second DLT node. For this purpose, the computer system 100 comprises a communication interface 116 for communication over the network 184.

In addition, the computer system 100 has a memory 102. For example, a protected memory area 106 of the memory 102 of the computer system 100 stores a private cryptographic key 108 of an asymmetric key pair assigned to the buyer. For example, this private cryptographic key 108 is used, for example, as a signature key to create electronic signatures for the seller. Corresponding signatures can be checked with a public cryptographic key 104 of the corresponding asymmetric key pair. For example, the public cryptographic key 104 is provided as part of a certificate. The computer system 100 makes this public cryptographic key 104, or the certificate comprising the public cryptographic key 104, available to other parties involved, such as the second DLT node of the seller implemented on the second DLT server, as a signature verification key.

Furthermore, the execution of the program instructions by the processor 142 causes the processor 142 to control the first DLT node in such a way that the DLT node receives at least one second update message from the second DLT node via an update of the second dataset 168 in the course of logging the goods delivery in the DLT system 182. This second update is an update using a second check result of checking one or more first sensor values of an outgoing goods log for consistency with the one or more physical properties of the goods to be delivered according to the shared dataset within predefined first tolerances. These one or more first sensor values of the outgoing goods log are acquired by means of one or more physical sensors 113 assigned to the seller. The checked first sensor values include at least the first sensor value quantifying the delivered quantity of goods. The first dataset 148 is then updated by the DLT node using the second update message.

Finally, the execution of the program instructions 144 by the processor 142 causes the processor 142 to control the first DLT node in such a way that the DLT node receives at least one third update message from the second DLT node about an update of the second dataset 168 using a validation message in the course of validating the goods delivery in the DLT system 182. The updating of the second dataset 168 using the validation message involves registering the validation message in the second dataset 168. In doing so, the updating of the second dataset 168 using the validation message confirms that the second DLT node has successfully checked the parameters of the validation message. These parameters include at least one quantity of goods to be validated. The checking of the parameters comprises checking the quantity of goods to be validated for consistency with the first sensor value quantifying the delivered quantity within a predefined second tolerance. Finally, the first DLT node updates the first dataset 148 through the DLT node using the third update message. Updating the first dataset 148 involves registering the validation message in the first dataset 148.

Executing the program instructions 164 by the processor 162 causes the processor 162 to control the second DLT server 160 such that the second DLT node implemented on the second DLT server 160 receives at least the first dataset 148 created by the first DLT node of the buyer in the course of initialising the goods delivery in the DLT system 182, which dataset comprises at least the one or more physical properties of the goods to be delivered according to the first specification of the delivery order. The second DLT node then creates the second dataset 168 managed by the DLT node. In addition, the second DLT node updates the created second dataset 168. The update comprises entering at least one or more physical properties of the first specification into the second dataset 168, which at least one or more entered physical properties of the first specification include the quantity of goods to be delivered.

Furthermore, the second DLT node receives the order confirmation of the seller from the computer system 100 of the seller via the network 184. The order confirmation includes the second specification of the one or more physical properties of the goods to be delivered. The second DLT node checks the second specification for consistency with the first specification using the one or more smart contract and updates the second dataset 168 using the resulting check result. Finally, the second DLT node sends at least the first update message to the first DLT node to update the first dataset 148.

The execution of the program instructions 164 by the processor 162 causes the processor 162 to also control the second DLT node in such a way that the DLT node receives the outgoing goods log from the sender via the first network 184 in the course of logging the goods delivery in the DLT system 182. For example, the second DLT node receives the outgoing goods log from the computer system 100 of the seller. The outgoing goods log comprises one or more first sensor values for the one or more physical properties of the outgoing goods according to the second specification, which are acquired by means of the one or more physical sensors 114 assigned to the seller.

The second DLT node checks the one or more first sensor values of the outgoing goods log for consistency with the one or more physical properties of the goods to be delivered according to the shared dataset, or the second partial dataset 168 of the shared dataset, within predefined first tolerances. To do this, the second DLT node uses one of the one or more smart contract. The checked first sensor values include at least the first sensor value quantifying the delivered quantity of goods. The second dataset 168 is updated by means of the second DLT node by using the check result. In addition, the second DLT node sends at least the second update message to the first DLT node to update the first dataset 148.

Finally, execution of the program instructions 164 by the processor 162 causes the processor 162 to control the second DLT node such that the second DLT node checks the parameters of the validation message for validating the goods delivery using the one or more smart contract in the course of validating the goods delivery in the DLT system 182. The parameters checked include at least the quantity of goods to be validated. The checking of the parameters comprises checking the quantity of goods to be validated for consistency with the first sensor value quantifying the delivered quantity of goods within the predefined tolerance. If the quantity of goods to be validated is consistent with the first sensor value quantifying the delivered quantity of goods within the predefined tolerance, the second DLT node updates the second dataset 168. This update involves registering the validation message by the second DLT node in the second dataset 168 using at least one of the one or more smart contracts. In addition, the second DLT node sends the corresponding update message for registering the validation message to the first DLT node for updating the first dataset 148.

According to alternative embodiments, the first DLT node and the second DLT node can also be implemented on a common DLT server of the DLT system 180. According to alternative embodiments, the first DLT node can also be implemented, for example, on the computer system 120 of the buyer and/or the second DLT node can be implemented on the computer system 100 of the seller.

FIG. 4 shows a schematic flow diagram of an exemplary method for computer-implemented monitoring of a goods delivery from a seller to a buyer. In step 300, the buyer sends a delivery order 190 to a DLT node associated with the buyer in the DLT system 182. In addition to an order number and a product number, this delivery order 190 specifies, for example, a quantity of the goods to be delivered as a physical property of the corresponding goods. This sending of the delivery order 190 results in a first partial dataset of a shared dataset being generated in the DLT system 182 using the delivery order 190. The data of the delivery order 190 is also transferred to the seller. The status of the goods delivery at this stage is “proposed”. In step 302, the seller sends an order confirmation 191 to a DLT node assigned to the seller in the DLT system 182. In addition to the order number and the product number, this order confirmation 191 specifies, for example, a quantity of the goods to be delivered as the physical property of the corresponding goods. For example, this confirmation is entered into a second partial dataset of the shared dataset on the DLT node of the seller in the DLT system 182. If the quantity specified in the order confirmation 191 is consistent with the quantity specified in the delivery order 190, the goods delivery assumes the status “confirmed” in the DLT system 182. The data of the order confirmation 191 or an update of the second partial dataset is also transferred to the buyer.

In addition, for example, in step 304, the buyer can send an update 192 of the delivery order 190 with a new quantity specification to the DLT system 182 or to the first DLT node assigned to the buyer in the DLT system 182. For example, the first DLT node enters this update of the specification of the goods delivery into the first partial dataset and also transfers this to the seller or to the second DLT node assigned to the seller. In this case, the status of the goods delivery in the DLT system 182 changes to “updated”, for example. In step 306, the seller sends an update 193 of the order confirmation 191 with the new quantity specification to the DLT system 182, or to the first DLT node assigned to the seller in the DLT system 182. The second DLT node enters this update of the confirmation of the specification of the goods delivery into the second partial dataset and also transfers this to the buyer or to the first DLT node assigned to the buyer. In this case, the status of the goods delivery in the DLT system 182 changes back to “confirmed”, for example. If the goods have been delivered, in step 194 the seller sends a validation message, for example, such as an invoice, to the DLT system for validation or for updating the shared dataset using the validation message 194. For example, the validation involves checking the validation message information with the specification of the goods delivery stored in the shared dataset. If these match, the validation message is registered in the shared dataset in the DLT system 182. For example, an invoice number of the validation message is stored in the shared dataset. In this case, the status of the goods delivery in the DLT system 182 changes to “completed”, for example.

FIG. 5 shows a further schematic flow diagram of an exemplary method for computer-implemented monitoring of a goods delivery from a seller to a buyer. In this case, a first DLT node of the buyer and a second DLT node of the seller, using one or more smart contracts, perform the following steps: In step 320, the first DLT node creates a first partial dataset of a shared dataset and updates this with data from a delivery order of the buyer. This first partial dataset is sent to the second DLT node of the seller. The second DLT node creates a second partial dataset of the shared dataset with the data from the delivery order. The status of the goods delivery at this stage is “proposed”. In step 322, the second DLT node updates the second partial dataset with data from an order confirmation from the seller. In addition, an update message about the update of the second partial dataset using the order confirmation is sent to the first DLT node of the buyer. The first DLT node updates the first partial dataset accordingly. Then, for example, one or more further update steps and/or a cancellation can be performed.

For example, in step 324, the first DLT node updates the first partial dataset based on an update to the delivery order. For example, the quantity, delivery date, price, etc. of the goods to be delivered are updated. This update is sent to the second DLT node. The second DLT node records this update in the second partial dataset. The status of the goods delivery thus changes to “updated”. In step 326, the second DLT node confirms the proposed update, for example, based on an updated order confirmation and enters this confirmation into the second partial dataset. This confirmation of the update is sent to the first DLT node. The first DLT node records this confirmation, for example in the first partial dataset. The status of the goods delivery then changes back to “confirmed”.

An update of the delivery conditions can also be initiated by the seller. For example, in step 328, the second DLT node updates the second partial dataset based on an update to the order confirmation. For example, the quantity, delivery date, price, etc. of the goods to be delivered are updated. This update is sent to the first DLT node. The first DLT node records this update, for example in the first partial dataset. The status of the goods delivery then changes to “updated”. In step 330, the first DLT node confirms the proposed update based, for example, on an updated delivery order and enters this confirmation into the first partial dataset. This confirmation of the update is sent to the second DLT node. The second DLT node records this confirmation in the second partial dataset. The status of the goods delivery then changes back to “confirmed”.

Likewise, the goods delivery can also be cancelled by the seller or the buyer. For example, in step 332, the first or second DLT node enters a cancellation into the first or second partial dataset based on a received cancellation notification. A cancellation message is also sent to the second or first DLT node. The second or first DLT node records the corresponding cancellation in the second or first partial dataset. In this case, the status of the goods delivery changes to “cancelled” and the method is completed.

If no cancellation is made, in step 334 the second DLT node updates the second partial dataset based on a check of the validation message, for example, upon a completed goods delivery. If the check is successful, the validation message is registered in the second partial dataset by, for example, an identifier of the validation message, such as an invoice number, being entered into the second partial dataset. This update is sent to the first DLT node. The first DLT node records this update, for example, in the first partial dataset by also registering the validation message. The status of the goods delivery then changes to “completed”.

Both the first and the second DLT node according to FIG. 5 may have one or more features of the DLT nodes according to FIG. 3 implemented on the first and second DLT server 140, 160. Further, the DLT nodes according to FIG. 5 may be configured, at least partially, to carry out the method according to FIGS. 1A and/or 1B or parts thereof.

FIG. 6 shows a further schematic flow diagram of an exemplary method for computer-implemented monitoring of a goods delivery from a seller to a buyer by using a DLT system 182. In step 350, the buyer, or a computer system 120 of the buyer, sends a delivery order to a first DLT node assigned to the buyer in the DLT system 182. In step 352, the seller or a computer system 100 of the seller sends an order confirmation to a second DLT node assigned to the seller in the DLT system 182. Based on the delivery order and the order confirmation, conditions for the goods delivery are entered into two partial datasets of a shared dataset and matched with each other in the course of a 2-way match. This ensures that the conditions of the delivery order and the order confirmation are consistent. In the course of performing the delivery of the goods to be delivered, in step 354 the seller, or a computer system 100 of the seller, sends an outgoing goods log to the second DLT node in the DLT system 182. The outgoing goods log comprises sensor values for physical properties of the outgoing goods, which were acquired by means of physical sensors of the seller and include at least one sensor value, which quantifies the delivered quantity of goods. In addition, in step 356 the seller, or a computer system 100 of the seller, sends a validation message to the second DLT node in the DLT system 182. Based on the result of the 2-way match, the outgoing goods log and the validation message, a 3-way match is performed to check whether the condition of the goods actually delivered and the conditions according to the 2-way match are consistent with the information in the validation message. This ensures that the information in the validation message is correct. If the check of the validation message is successful, this is registered in the shared dataset.

FIG. 7 shows a further schematic block diagram of an exemplary system for computer-implemented monitoring of a goods delivery from a seller to a buyer, including an electronic transaction. The system may comprise a DLT system 182, for example, the DLT system according to embodiments of FIG. 3 or 4. Payment transactions can be coupled with data flows from the monitoring of the goods delivery and kept in a closed data circuit.

To prepare electronic payments, in step 360 subscribers, such as User A, can transfer bank money, for example euros, to a pool account of a bank that handles the payment transactions. This is carried out within a banking system or by using a bank computer system 186. In step 362, the bank or a DLT node associated with the bank in the DLT system 182 records the receipt of bank money, for example, via a bank API or another suitable programming or communication interface of the bank, in the DLT system 182. An API (Application Programming Interface) is a programming interface or part of a program that a software system makes available to other programs for integrating to the corresponding system. In step 364, the bank automatically allocates E-money, i.e. electronic money, to a DLT account of the user A. The amount of E-money received into the DLT account of User A is equal to the amount of bank money transferred. Each subscriber, e.g. User B, can perform a corresponding method to allocate electronic money to an associated DLT account in the DLT System 182. The DLT accounts can be provided on the respective DLT nodes of the subscribers in the DLT system 182.

User A, as the buyer, can place an order with a seller, e.g. User B, on an ERP system. For example, the order is submitted as a delivery order to a DLT node of User A in step 366. The delivery order can contain ERP data from the ERP system of the buyer. For this purpose, user A, for example, can use a computer system of the buyer, which can be connected to the associated DLT node in the DLT system 182 via an API or any other programming or communication interface. The DLT node of user A initialises the goods delivery as described above, e.g. with regard to the embodiment according to FIG. 1A. This causes an order specification to be sent to a DLT node of the seller, which can transfer the order specification to a computer system of the seller in step 368. User B can confirm the order, for example, using an ERP system on the computer system of the seller. For example, the order specification and confirmation may contain ERP data from the ERP system of the seller. The computer system of the seller can be connected to the associated DLT node in the DLT system 182 via an API or any other programming or communication interface.

The ordering process is handled by the DLT system 182 between the DLT nodes of the seller and the buyer using one or more smart contracts, an example of which is illustrated in step 370. This is carried out, for example, using one of the exemplary methods described in the preceding figures for monitoring a goods delivery from a seller to a buyer using the access-restricted DLT system 182. If a handshake is required, this can be implemented (semi-)automatically between the DLT nodes involved. If additional data is required or parameters need to be confirmed, the DLT nodes involved can communicate with the associated computer systems of the seller or the buyer in order to receive inputs, e.g. via the respective ERP systems, which are then entered into the DLT system 182. Accordingly, the ordering process and the goods delivery can be carried out via the DLT system 182.

A goods delivery and, if necessary, a despatch of an invoice, which must be carried out due to requirements outside of the DLT system 182, can be carried out in step 372.

Upon registration of a validation message of the goods delivery, for example by issuing the invoice, in the DLT system 182, an electronic payment transaction can be triggered from the DLT account of User A to a DLT account of User B.

As with the issuance of electronic money on DLT accounts in the DLT system, in step 374 a subscriber, for example User B, can at least partially pay out the electronic money received in the course of one or more electronic payment transactions by bank transfer. This can be carried out via the DLT node assigned to the bank, which can communicate with the bank computer system. In step 376, the bank changes the E-money paid out into bank money and transfers the corresponding bank money via the pool account to an account of User B. Each subscriber, e.g. User A, can carry out a corresponding method to pay out E-money as bank money to an associated bank account. It should be clear that the goods delivery does not necessarily entail the payment of electronic money as bank money. Instead, the E-money can remain in DLT accounts to make further electronic payment transactions.

The DLT System 182 may also be configured to record and verify all DLT payment transactions in the DLT System 182, for example for AML (Anti-Money Laundering) reasons, i.e. to prevent money laundering, by the bank. For example, anti-money laundering software belonging to the bank is used to verify the recorded DLT transactions. For example, customer data is analysed to detect suspicious transactions. To do this, the customer data is filtered, classified according to the level of trust and examined for anomalies. For example, once the anti-money laundering software has collected sufficient data and suspicious cases have been flagged, a report is generated. Payments may also be released or blocked.

For example, the DLT system 182 also ensures that all payment transactions are processed in compliance with regulations: for example, using the at least one smart contract, a regulator 378 is implemented, which collects all transactions for compliance purposes. Furthermore, using the at least one smart contract, for example, a notary 380 is implemented, which prevents multiple use or multiple issuance of the same units of E-money.

FIGS. 8A and 8B as well as FIG. 9 show an exemplary graphical user interface (GUI) for carrying out the method for computer-implemented monitoring of a goods delivery from a seller to a buyer by using an access-restricted DLT system. FIG. 8A shows a the first part of a first exemplary graphical user interface. FIG. 8A comprises an exemplary representation of the data of a first partial dataset 148 of a shared dataset, which reproduces a delivery order of a goods recipient (“Buyer”). Furthermore, FIG. 8B shows a second part of the first exemplary graphical user interface. FIG. 8B comprises an exemplary representation of the data of a second partial dataset 168 of the shared dataset, which reproduces a proposal for modified delivery conditions on the part of the goods supplier (“Seller”).

The graphical user interface shown in FIGS. 8A and 8B includes a menu for selecting different fields. These include a “Dashboard”, i.e. a graphical user interface for visualising data, an “Orders” field, a “Wallet”, i.e. a eWallet, a digital wallet or electronical wallet, a field for “Reports”, and a field for “Settings”. A current user is also indicated (“Logged in as”). A selection button for creating a new order (“Create new order”) is also shown. Search parameters can also be entered (“Search and filter”). FIGS. 8A and 8B show an example of a field showing “Orders”. The following fields can be selected in a sub-menu: “Open”, “Confirmed”, “Paid”, and “Rejected”. Each of these fields lists open, confirmed, paid, or rejected orders. The graphical user interface includes a Buyer field for a goods recipient and a Seller field for a goods supplier.

The representation of the first partial dataset 148 of the buyer in FIG. 8A shows what the buyer sees, i.e. “Buyer-Their View”, indicating, for example, a time of the last update “Last update”, a status “UPDATED”, a “Transaction ID”, an “Order Number”, a “Delivery Date”, a “Product ID buyer”, a “Product Name buyer”, A “Product ID seller”, a “Product name seller”, a “Line Item ID”, a “Settlement (In Days)” item, an “Invoice number”, an “Invoice date”, a “Tax ID”, a “Tax” item, a “Description”, a reason for the update “Update reason”, a “Quantity”, an indication of “Units”, a “Price per unit”, a “Unit of price per Unit”, a “Total price”, and a “Currency”. In addition, a selection element “Accept all” is provided for the seller in order to accept all information or specifications in accordance with the first partial dataset 148 of the buyer.

The representation of the second partial dataset 168 of the seller in FIG. 8B shows what the seller sees, i.e. “Seller-My View”, if the user is logged in as a seller of goods, indicating, for example: a time of the last update “Last update”, a status “UPDATED”, a “Transaction ID”, an “Order Number”, a “Delivery Date”, a “Product ID buyer”, a “Product name buyer”, a “Product ID seller”, a “Product Name seller”, a “Line Item ID”, a “Settlement (In days)” item, an “Invoice number”, an “Invoice date”, a “Tax ID”, a “tax” item, a “Description”, an “Update reason”, a “Quantity”, a “Units” item, a “Price per unit”, a “Unit of price per Unit”, a “Total price”, and a “Currency”. This information can be changed by the seller except for the time of the last update “Last update”, the status “UPDATED”, the “Transaction ID”, the “Order number”, the “Product ID buyer” and the “Product name buyer”. In addition, selection items Cancel, Send, and Confirm is provided to cancel, send, or confirm the information or updates to the information respectively.

FIG. 9 shows an example dashboard of a DLT node of a seller with an overview of current orders and payments. The graphical user interface shown in FIG. 9 includes a menu for selecting different fields. These include a “Dashboard”, i.e. a graphical user interface for visualising data, an “Orders” field, a “Wallet”, i.e. a eWallet, digital wallet or electronical wallet, a field for “Reports”, and a field for “Settings”. Furthermore, there is an indication of who is currently logged in “Logged In As”. FIG. 9 shows an example of the Dashboard. The dashboard includes information on “Cash available now”, “Cash available tomorrow” and “Cash available the day after tomorrow”. The dashboard also includes an “Overview”, a listing of “Most recent orders”, “Most recent updates”, and “Paid on time” payments. The Overview field comprises a graphical representation, e.g. in the form of a histogram, of various information for the current date “Today”. This information includes a “Wallet saldo”, details of inbound payments “Incoming”, outbound payments “Outgoing”, and rejected payments and/or delivery orders under “Rejected”. The “Most recent orders” list contains a list of current orders and specifies, for example, how many current orders are left that are not listed. The “Most recent updates” list contains the latest updates and indicates, for example, when a most recent update occurred (“Last updated”). For example, this occurred “4 minutes ago”. Finally, the “Paid on time” list indicates the percentage of incoming goods “Incoming” and the percentage of outgoing goods “Outgoing” that were paid on time. Finally, the dashboard contains information about a number of “Transactions” that are ongoing (“Pending”), which are yet to be completed (“To dos”), which are paid (“Paid”) and which are rejected (“Rejected”).

The invention has been described in the foregoing in an exemplary form with reference to specific embodiments. The present invention can also be further described without restriction and purely by way of example by the following embodiments. The following embodiments may include preferred embodiments. Accordingly, the term “feature combination” as used therein may refer to such a “preferred embodiment”.

1. Method for computer-implemented monitoring of a goods delivery from a seller to a buyer using an access-restricted DLT system, which comprises a first DLT node assigned to the buyer and a second DLT node assigned to the seller, wherein the DLT system provides at least one smart contract, comprising program instructions for entering and checking delivery orders and order confirmations,

wherein the method comprises initialising the goods delivery in the DLT system, the initialisation comprising:
receiving a delivery order of the buyer relating to goods to be delivered by the seller to the buyer via a first network by means of the first DLT node, wherein the delivery order defines one or more physical properties of the goods to be delivered as a first specification, the physical properties of the first specification comprising at least one quantity of goods to be delivered,
creating a first dataset managed by the first DLT node and entering at least the one or more physical properties of the delivery order into the first dataset by means of the first DLT node by using the at least one smart contract, wherein the first dataset is a first part of a dataset shared between the first DLT node and the second DLT node,
transferring at least the first dataset from the first DLT node to the second DLT node,
creating a second dataset managed by the second DLT node, wherein the second dataset is a second part of the shared dataset, and performing a first update of the second dataset by means of the second DLT node based on the first dataset, wherein the first update comprises entering at least one or more of the physical properties of the first specification into the second dataset, the at least one or more entered physical properties of the first specification comprising the quantity of goods to be delivered,
receiving an order confirmation of the seller via the first network by means of the second DLT node, wherein the order confirmation comprises a second specification of the one or more physical properties of the goods to be delivered,
checking the second specification for consistency with the first specification by using the at least one smart contract,
performing a second update of the second dataset by means of the second DLT node by using a first result of the check of the second specification,
transferring at least a first update message from the second DLT node to the first DLT node,
performing a first update of the first dataset by means of the first DLT node by using the first update message.

2. Method according to feature combination 1, wherein the at least one smart contract comprises program instructions for entering and checking outgoing goods logs in the course of goods deliveries from the seller to the buyer, wherein the method also comprises logging of the goods delivery in the DLT system, the logging comprising:
receiving an outgoing goods log from the seller via the first network by means of the second DLT node, wherein the outgoing goods log comprises one or more first sensor values for the one or more physical properties of the outgoing goods according to the second specification, which are detected by means of one or more first physical sensors assigned to the seller, the one or more first sensor values comprising at least one first sensor value which quantifies the delivered quantity of goods,
checking the one or more first sensor values of the outgoing goods log for compliance with the one or more physical properties of the goods to be delivered according to the shared dataset within predefined first tolerances by using the at least one smart contract, wherein the checked first sensor values comprise at least the first sensor value quantifying the quantity of goods delivered,
performing a third update of the second dataset by means of the second DLT node by using a second result of checking the one or more first sensor values of the outgoing goods log,
transmitting at least a second update message from the second DLT node to the first DLT node,
performing a second update of the first dataset by means of the first DLT node by using the second update message.

3. Method according to one of the feature combinations 1 or 2, wherein the at least one smart contract comprises program instructions for validating the goods deliveries, the method further comprising validating the goods delivery in the DLT system, wherein the validation comprises:
checking parameters of a validation message for validating the goods delivery by means of the second DLT node by using the at least one smart contract, wherein the parameters comprise at least one quantity of goods to be validated, the parameter checking comprising checking the quantity of goods to be validated for compliance with the first sensor value quantifying the quantity of goods delivered within a predefined second tolerance,
if the quantity of goods to be validated is consistent with the first sensor value quantifying the quantity of goods delivered within the predefined second tolerance, performing a fourth update of the second dataset by means of the second DLT node, wherein the fourth update comprises registering the validation message in the second dataset by means of the second DLT node using the at least one smart contract,
transferring at least a third update message from the second DLT node to the first DLT node,
performing a third update of the first dataset by means of the first DLT node by using the third update message, wherein the third update of the first dataset comprises registering the validation message in the first dataset.

4. Method according to any one of the preceding feature combinations, further comprising signing the data transferred from the first DLT node to the second DLT node by means of the first DLT node, wherein the at least one smart contract on the second DLT node is configured to check the signatures of the transferred data.

5. Method according to any one of the preceding feature combinations, further comprising signing the data transferred from the second DLT node to the first DLT node by means of the second DLT node, wherein the at least one smart contract on the second DLT node is configured to check the signatures of the transferred data.

6. Method according to any one of the preceding feature combinations, wherein the data transfer between the first DLT node and the second DLT node is carried out via one or more communication links cryptographically protected using end-to-end encryption.

7. Method according to feature combination 6, wherein establishing the one or more cryptographically protected communication connections comprises a mutual authentication of the first DLT node and the second DLT node in each case.

8. Method according to any one of the preceding feature combinations, wherein the checking of the second specification for consistency with the first specification in the course of the initialisation is an identity check.

9. Method according to feature combination 8, wherein the initialisation further comprises:
if the one or more physical properties according to the second specification that are entered in the second dataset differ from the one or more physical properties according to the first specification from the first dataset, performing a handshake between the first DLT node and the second DLT node to match the first specification of the first dataset and the second specification of the second dataset, so that the first and second specifications resulting from the matching are identical.

10. Method according to one of the feature combinations 1 to 7, wherein the checking of the second specification for consistency with the first specification during the initialisation is a check for consistency within predefined third tolerances in accordance with the at least one smart contract.

11. Method according to feature combination 10, wherein the initialisation further comprises:

if one or more deviations between the one or more physical properties according to the second specification entered in the second dataset and the one or more physical properties according to the first specification from the first dataset are greater than the predefined third tolerances, performing a handshake between the first DLT node and the second DLT node to match the first specification of the first dataset and the second specification of the second dataset so that the first and second specifications resulting from the matching are identical within the predefined third tolerances.

12. Method according to any one of the preceding feature combinations, wherein the program instructions comprised by the at least one smart contract are additionally configured for entering and checking incoming goods logs in the course of goods deliveries from the seller to the buyer, wherein the logging of the goods delivery in the DLT system further comprises:
receiving an incoming goods log from the buyer via the first network by means of the first DLT node, wherein the incoming goods log comprises one or more second sensor values for the one or more physical properties of the incoming goods according to the first specification, which are detected by means of one or more of the second physical sensors assigned to the buyer, wherein the one or more second sensor values comprise at least one second sensor value which quantifies the delivered quantity of goods,
checking the one or more second sensor values of the incoming goods log for consistency with the one or more physical properties of the goods to be delivered according to the shared dataset and with the one or more first sensor values according to the outgoing goods log within predefined fourth tolerances by using the at least one smart contract, wherein the second sensor values checked comprise at least the second sensor value quantifying the quantity of goods delivered,
performing a fourth update of the first dataset by means of the first DLT node by using a third result of checking the one or more second sensor values of the incoming goods log,
transferring at least a fourth update message from the first DLT node to the second DLT node,
performing a fifth update of the second dataset by means of the second DLT node by using the fourth update message.

13. Method according to any one of the preceding feature combinations, wherein the validation message comprises an invoice and the program instructions comprised by the at least one smart contract are further configured to create the invoice, wherein the invoice creation is carried out by the second DLT node using the at least one smart contract, the validation message parameters being checked in the course of the invoice creation.

14. Method according to one of the feature combinations 1 to 12, wherein an invoice is received from a first ERP system of the seller which creates the invoice.

15. Method according to any one of the preceding feature combinations, wherein the data entered in the shared dataset provided in the DLT system in the course of logging the goods delivery is mirrored data of the goods delivery from the first ERP system of the seller and/or a second ERP system of the buyer, wherein the first and/or second ERP system are configured to control the processing of the goods delivery, wherein data consistency between the shared dataset and the ERP systems is ensured by entering the mirrored data.

16. Method according to one of the feature combinations 1 to 14, wherein the processing of the goods delivery is controlled by the at least one smart contract, the program instructions of which are also configured to control the processing of the goods delivery.

17. Method according to any one of the preceding feature combinations, wherein the first network is a public network.

18. Method according to any one of the preceding feature combinations, wherein a prerequisite for receiving the delivery order of the buyer by means of the first DLT node is a successful authentication of the buyer by the first DLT node, and/or
wherein a prerequisite for receiving the order confirmation of the seller by means of the second DLT node is a successful authentication of the seller by the second DLT node, and/or
wherein a prerequisite for receiving the outgoing goods log from the seller by means of the second DLT node is a successful authentication of the seller by the second DLT node, and/or
wherein a prerequisite for receiving the incoming goods log from the buyer by the first DLT node is a successful authentication of the buyer by the first DLT node.

19. Method according to any one of the preceding feature combinations, wherein a prerequisite for using the delivery order of the buyer by means of the first DLT node is a successful signature check of a buyer's signature by the first DLT node, and/or
wherein a prerequisite for using the order confirmation of the seller by means of the second DLT node is a successful signature check of a signature of the order confirmation by the second DLT node, and/or
wherein a prerequisite for the use of the outgoing goods log from the seller by the second DLT node is a successful signature check of a signature of the outgoing goods log by the second DLT node, and/or
wherein a prerequisite for the use of the incoming goods log of the buyer by means of the first DLT node is a successful signature check of a signature of the incoming goods log by means of the first DLT node.

20. Method according to any of the preceding feature combinations, wherein the first DLT node and the second DLT node are provided by one or more DLT servers of the DLT system.

21. Method according to feature combination 20, wherein the one or more DLT servers of the DLT system are arranged in one or more data centres secured against unauthorised access.

22. Method according to any one of the preceding feature combinations, wherein the data transmission between the DLT nodes takes place via a second network.

23. Method according to feature combination 22, the second network being a private or a public network.

24. Method according to any one of the preceding feature combinations, wherein the program instructions comprised by the at least one smart contract are further configured for triggering an electronic payment transaction, wherein the payment transaction by the smart contract is triggered upon the registration of the validation message in the DLT system.

25. Method according to feature combination 24, wherein the triggered electronic payment transaction is a bank transfer, such as an IBAN transfer from an IBAN account of the buyer to an IBAN account of the seller.

26. Method according to feature combination 24, wherein the triggered electronic payment transaction is a transaction of an amount of digital money performed using the DLT system.

27. Method according to feature combination 26, wherein the DLT system is configured to transfer the invoice amount to be paid from an account belonging to the buyer for digital money to an account belonging to the seller for digital money, wherein the DLT system is further configured, for example, to transform an amount of bank money of a bank money account assigned to the buyer into an amount of the digital money on the account belonging to the buyer for digital money.

28. Method according to one of the feature combinations 26 or 27, wherein the payment transaction is logged in the DLT system using the at least one smart contract, wherein by using the smart contract, for example, electronic account statements relating to the logged payment transaction are also issued for the buyer and/or the seller.

29. Shared dataset of an access-restricted DLT system for computer-implemented monitoring of a goods delivery from a seller to a buyer using the DLT system, wherein the shared dataset comprises a first part, the first part being a first dataset managed by a first DLT node assigned to the buyer, and wherein the shared dataset further comprises a second part, the second part being a second dataset managed by a second DLT node assigned to the seller.

30. Use of a shared dataset according to feature combination 29 for initialising the goods delivery in the DLT system.

31. Use of the shared dataset according to feature combination 29 for logging the goods delivery in the DLT system.

32. Use of the shared dataset according to feature combination 29 for validating the goods delivery in the DLT system.

33. DLT node of an access-restricted DLT system for computer-implemented monitoring of a goods delivery from a seller to a buyer, wherein the DLT node is implemented on a DLT server of the DLT system and is assigned to the buyer, wherein the DLT server comprises a processor and a memory with program instructions, wherein at least one smart contract is provided on the DLT node by the program instructions, wherein the program instructions providing the at least one smart contract comprise program instructions for entering and checking delivery orders and order confirmations,

wherein execution of the program instructions by the processor causes the processor to control the DLT node in such a way that in the course of initialising the goods delivery in the DLT system the DLT node executes the following:
receiving a delivery order of the buyer relating to goods to be delivered by the seller to the buyer via a first network by means of the first DLT node, wherein the delivery order defines one or more physical properties of the goods to be delivered as a first specification, the physical properties of the first specification comprising at least one quantity of goods to be delivered,
creating a first dataset managed by the DLT node and entering at least the one or more physical properties of the delivery order into the first dataset by means of the DLT node by using the at least one smart contract, wherein the first dataset is a first part of a dataset shared between the first DLT node and a further DLT node of the DLT system, assigned to the seller,
transferring at least the first dataset from the DLT node to the further DLT node,
receiving at least one first update message from the further DLT node via an update of the second dataset using a first check result of checking a second specification of the one or more physical properties of the goods to be delivered according to an order confirmation for consistency with the first specification,
performing a first update of the first dataset by means of the DLT node by using the first update message.

34. DLT node according to feature combination 33, wherein the program instructions providing the at least one smart contract comprise program instructions for entering and checking outgoing goods logs in the course of goods deliveries from the seller to the buyer, wherein the execution of the program instructions by the processor causes the processor additionally to control the DLT node such that in the course of logging the goods delivery to the DLT system, the DLT node carries out the following:
receiving at least one second update message from the further DLT node via an update of the second dataset using a second check result of checking one or more first sensor values of an outgoing goods log for consistency with the one or more physical properties of the goods to be delivered according to the shared dataset within predefined first tolerances, wherein the one or more first sensor values of the outgoing goods log are detected by means of one or more first physical sensors assigned to the seller, wherein the checked first sensor values comprise at least the first sensor value quantifying the quantity of goods delivered,
performing a second update of the first dataset by means of the first DLT node by using the second update message.

35. DLT node according to one of the feature combinations 33 or 34, wherein the program instructions providing the at least one smart contract comprise program instructions for a validation of the goods deliveries, wherein the execution of the program instructions by the processor causes the processor further to control the DLT node such that in the course of validating the goods delivery in the DLT system the DLT node performs the following:
receiving at least a third update message from the further DLT node via an update of the second dataset using a validation message, wherein the updating of the second dataset using the validation message comprises registering the validation message in the second dataset, wherein the updating of the second dataset using the validation message confirms a successful check of parameters of the validation message by the further DLT node, wherein the parameters comprise at least one quantity of goods to be validated, wherein the checking of the parameters comprises checking the quantity of goods to be validated for consistency with the first sensor value quantifying the delivered quantity of goods within a predefined second tolerance,
performing a third update of the first dataset by means of the DLT node by using the third update message, wherein the third update of the first dataset comprises registering the validation message in the first dataset.

36. DLT node according to one of the feature combinations 33 to 35, wherein the execution of the program instructions by the processor causes the processor to control the DLT node in such a way that the DLT node executes the method steps of the first DLT node of the method according to any one of the feature combinations 4 to 28.

37. DLT node of an access-restricted DLT system for computer-implemented monitoring of a goods delivery from a seller to a buyer, wherein the DLT node is implemented on a DLT server of the DLT system and is assigned to the seller, wherein the DLT server comprises a processor and a memory with program instructions, wherein at least one smart contract is provided on the DLT node by the program instructions, wherein the program instructions providing the at least one smart contract comprise program instructions for entering and checking delivery orders and order confirmations,

wherein execution of the program instructions by the processor causes the processor to control the DLT node in such a way that in the course of initialising the goods delivery in the DLT system the DLT node executes the following:
receiving at least one first dataset created by a further DLT node of the buyer from the other DLT node, the first dataset being a first part of a dataset shared between the DLT node and the further DLT node, wherein the first dataset comprises at least one or more physical properties of the goods to be delivered in accordance with a first specification of a delivery order, the physical characteristics of the first specification comprising at least one quantity of goods to be delivered,
creating a second dataset managed by the DLT node, wherein the second dataset is a second part of the shared dataset, and performing a first update of the second dataset by means of the DLT node based on the first dataset, wherein the first update comprises entering at least one or more of the physical properties of the first specification into the second dataset, the at least one or more entered physical properties of the first specification comprising the quantity of goods to be delivered,
receiving an order confirmation of the seller via a first network by means of the DLT node, wherein the order confirmation comprises a second specification of the one or more physical properties of the goods to be delivered,
checking the second specification for consistency with the first specification by using the at least one smart contract,
performing a second update of the second dataset by means of the second DLT node by using a first result of the check of the second specification,
transferring at least one third update message from the DLT node to the further DLT node in order to update the first dataset.

38. DLT node according to feature combination 37, wherein the program instructions providing the at least one smart contract comprise program instructions for entering and checking outgoing goods logs in the course of goods deliveries of the seller to the buyer, wherein the execution of the program instructions by the processor causes the processor additionally to control the DLT node such that in the course of logging the goods delivery to the DLT system, the DLT node carries out the following:
receiving an outgoing goods log from the sender via the first network by means of the DLT node, wherein the outgoing goods log comprises one or more first sensor values for the one or more physical properties of the outgoing goods according to the second specification, which are detected by means of one or more of the first physical sensors assigned to the seller, wherein the one or more first sensor values comprise at least one first sensor value which quantifies the delivered quantity of goods,
checking the one or more first sensor values of the outgoing goods log for compliance with the one or more physical properties of the goods to be delivered according to the shared dataset within predefined first tolerances by using the at least one smart contract, wherein the checked first sensor values comprise at least the first sensor value quantifying the quantity of goods delivered,
performing a third update of the second dataset by means of the DLT node by using a second result of checking the one or more first sensor values of the outgoing goods log,
transferring at least one second update message from the DLT node to the further DLT node in order to update the first dataset.

39. DLT node according to one of the feature combinations 37 or 38, wherein the program instructions providing the at least one smart contract comprise program instructions for validating the goods deliveries, wherein the execution of the program instructions by the processor causes the processor to control the DLT node such that in the course of validating the goods delivery in the DLT system the DLT node performs the following:
checking parameters of a validation message for validating the goods delivery by means of the DLT node by using the at least one smart contract, wherein the parameters comprise at least one quantity of goods to be validated, the parameter checking comprising checking the quantity of goods to be validated for compliance with the first sensor value quantifying the quantity of goods delivered within a predefined second tolerance,
if the quantity of goods to be validated is consistent with the first sensor value quantifying the quantity of goods delivered within the predefined second tolerance, performing a fourth update of the second dataset by the DLT node, wherein the fourth update comprises registering the validation message in the second dataset by means of the DLT node by using the at least one smart contract,
transferring at least one third update message from the DLT node to the further DLT node in order to update the first dataset.

40. DLT node according to one of the feature combinations 37 to 39, wherein the execution of the program instructions by the processor causes the processor to control the DLT node in such a way that the DLT node executes the method steps of the second DLT node of the method according to any one of the feature combinations 4 to 28.

41. DLT system for computer-implemented monitoring of a goods delivery from a seller to a buyer, which comprises a first DLT node assigned to the buyer and a second DLT node assigned to the seller, wherein the first DLT node and the second DLT node are provided by one or more DLT servers of the DLT system, wherein the DLT system provides at least one smart contract, the at least one smart contract comprising program instructions for entering and checking delivery orders and order confirmations,

wherein the DLT system is configured to initialise the goods delivery in the DLT system, the initialisation comprising:
receiving a delivery order of the buyer relating to goods to be delivered by the seller to the buyer via a first network by means of the first DLT node, wherein the delivery order defines one or more physical properties of the goods to be delivered as a first specification, the physical properties of the first specification comprising at least one quantity of goods to be delivered,
creating a first dataset managed by the first DLT node and entering at least the one or more physical properties of the delivery order into the first dataset by means of the first DLT node by using the at least one smart contract, wherein the first dataset is a first part of a dataset shared between the first DLT node and the second DLT node,
transferring at least the first dataset from the first DLT node to the second DLT node,
creating a second dataset managed by the second DLT node, wherein the second dataset is a second part of the shared dataset, and performing a first update of the second dataset by means of the second DLT node based on the first dataset, wherein the first update comprises entering at least one or more of the physical properties of the first specification into the second dataset, the at least one or more entered physical properties of the first specification comprising the quantity of goods to be delivered,
receiving an order confirmation of the seller via the first network by means of the second DLT node, wherein the order confirmation comprises a second specification of the one or more physical properties of the goods to be delivered,
checking the second specification for consistency with the first specification by using the at least one smart contract,
performing a second update of the second dataset by means of the second DLT node by using a first result of the check of the second specification,
transferring at least a first update message from the second DLT node to the first DLT node,
performing a first update of the first dataset by means of the first DLT node by using the first update message.

42. DLT system according to feature combination 41, wherein the at least one smart contract comprises program instructions for entering and checking outgoing goods logs in the course of goods deliveries from the seller to the buyer, wherein the DLT system is further configured to execute a logging of the goods delivery in the DLT system, the logging comprising:
receiving an outgoing goods log from the sender via the first network by means of the second DLT node, wherein the outgoing goods log comprises one or more first sensor values for the one or more physical properties of the outgoing goods according to the second specification, which are detected by means of one or more of the first physical sensors assigned to the seller, wherein the one or more first sensor values comprise at least one first sensor value which quantifies the delivered quantity of goods,
checking the one or more first sensor values of the outgoing goods log for consistency with the one or more physical properties of the goods to be delivered according to the split dataset within predefined first tolerances by using the at least one smart contract, wherein the checked first sensor values comprise at least the first sensor value quantifying the quantity of goods delivered,
performing a third update of the second dataset by means of the second DLT node by using a second result of checking the one or more first sensor values of the outgoing goods log,
transmitting at least a second update message from the second DLT node to the first DLT node,
performing a second update of the first dataset by means of the first DLT node by using the second update message.

43. DLT system according to one of the feature combinations 41 or 42, wherein the at least one smart contract comprises program instructions for validating the goods deliveries, wherein the DLT system is further configured to perform a validation of the goods delivery in the DLT system, the validation comprising:
checking parameters of a validation message for validating the goods delivery by means of the second DLT node by using the at least one smart contract, wherein the parameters comprise at least one quantity of goods to be validated, the parameter checking comprising checking the quantity of goods to be validated for consistency with the first sensor value quantifying the quantity of goods delivered within a predefined second tolerance,
if the quantity of goods to be validated is consistent with the first sensor value quantifying the quantity of goods delivered within the predefined second tolerance, performing a fourth update of the second dataset by means of the second DLT node, wherein the fourth update comprises registering the validation message in the second dataset by means of the second DLT node by using the at least one smart contract,
transferring at least one third update message from the second DLT node to the first DLT node,
performing a third update of the first dataset by means of the first DLT node by using the third update message, wherein the third update of the first dataset comprises registering the validation message in the first dataset.

44. DLT system according to any of the feature combinations 41 to 43, wherein the DLT system is further configured to execute the method according to any of the feature combinations 4 to 28.

45. Computer program for monitoring a goods delivery from a seller to a buyer using an access-restricted DLT system, which comprises a first DLT node assigned to the buyer and a second DLT node assigned to the seller, wherein the computer program provides at least one smart contract, the at least one smart contract comprising program instructions for entering and checking delivery orders and order confirmations, wherein the computer program comprises program instructions for initialising the goods delivery in the DLT system, the initialisation comprising:
receiving a delivery order of the buyer via a first network by means of the first DLT node relating to goods to be delivered from the seller to the buyer, wherein the delivery order defines one or more physical properties of the goods to be delivered as a first specification, the physical properties of the first specification comprising at least one quantity of goods to be delivered,
creating a first dataset managed by the first DLT node and entering at least the one or more physical properties of the delivery order into the first dataset by means of the first DLT node by using the at least one smart contract, wherein the first dataset is a first part of a dataset shared between the first DLT node and the second DLT node,
transferring at least the first dataset from the first DLT node to the second DLT node,
creating a second dataset managed by the second DLT node, wherein the second dataset is a second part of the shared dataset, and performing a first update of the second dataset by means of the second DLT node based on the first dataset, wherein the first update comprises entering at least one or more of the physical properties of the first specification into the second dataset, the at least one or more entered physical properties of the first specification comprising the quantity of goods to be delivered,
receiving an order confirmation of the seller via the first network by means of the second DLT node, wherein the order confirmation comprises a second specification of the one or more physical properties of the goods to be delivered,
checking the second specification for consistency with the first specification by using the at least one smart contract,
performing a second update of the second dataset by means of the second DLT node by using a first result of the check of the second specification,
transferring at least one first update message from the second DLT node to the first DLT node,
performing a first update of the first dataset by means of the first DLT node by using the first update message.

46. Computer program according to feature combination 45, wherein the at least one smart contract comprises program instructions for entering and checking outgoing goods logs in the course of goods deliveries from the seller to the buyer, wherein the computer program further comprises program instructions for logging the goods delivery in the DLT system, the logging comprising:
receiving an outgoing goods log from the sender via the first network by means of the second DLT node, wherein the outgoing goods log comprises one or more first sensor values for the one or more physical properties of the outgoing goods according to the second specification, which are detected by means of one or more of the first physical sensors assigned to the seller, wherein the one or more first sensor values comprise at least one first sensor value which quantifies the delivered quantity of goods,
checking the one or more first sensor values of the outgoing goods log for consistency with the one or more physical properties of the goods to be delivered according to the split dataset within predefined first tolerances by using the at least one smart contract, wherein the checked first sensor values comprise at least the first sensor value quantifying the quantity of goods delivered,
performing a third update of the second dataset by means of the second DLT node by using a second result of checking the one or more first sensor values of the outgoing goods log,
transmitting at least a second update message from the second DLT node to the first DLT node,
performing a second update of the first dataset by means of the first DLT node by using the second update message.

47. Computer program according to one of the feature combinations 45 or 46, wherein the at least one smart contract comprises program instructions for validating the goods deliveries, wherein the computer program further comprises program instructions for validating the goods delivery in the DLT system, the validation comprising:
checking parameters of a validation message for validating the goods delivery by means of the second DLT node by using the at least one smart contract, wherein the parameters comprise at least one quantity of goods to be validated, the parameter checking comprising checking the quantity of goods to be validated for compliance with the first sensor value quantifying the quantity of goods delivered within a predefined second tolerance,
if the quantity of goods to be validated is consistent with the first sensor value quantifying the quantity of goods delivered within the predefined second tolerance, performing a fourth update of the second dataset by means of the second DLT node, wherein the fourth update comprises registering the validation message in the second dataset by means of the second DLT node by using the at least one smart contract,
transferring at least a third update message from the second DLT node to the first DLT node,
performing a third update of the first dataset by means of the first DLT node by using the third update message, wherein the third update of the first dataset comprises registering the validation message in the first dataset.

48. Computer program according to one of the feature combinations 45 to 47, wherein the computer program further comprises program instructions for carrying out the method according to one of the feature combinations 4 to 28.

### LIST OF REFERENCE SYMBOLS

100 seller computer system
102 memory
104 public key
106 protected memory area
108 private key
110 processor
112 program instruction
114 sensor
116 communication interface
120 buyer computer system
122 memory
124 public key
126 protected memory area
128 private key
130 processor
132 program instruction
134 sensor
136 communication interface
140 DLT server
142 processor
144 program instructions
146 memory
148 first dataset of the shared dataset
150 public key
152 protected memory area
154 private key
156 communication interface
160 DLT server
162 processor
164 program instructions
166 memory
168 second dataset of the shared dataset
170 public key
172 protected memory area
174 private key
176 communication interface
180 DLT network
182 DLT system
184 Network
186 bank computer system
190 delivery order
191 order confirmation
192 updated delivery order
193 updated order confirmation
194 validation message

What is claimed is:

1. A method for computer-implemented monitoring of a goods delivery from a seller to a buyer using an access-restricted distributed ledger technology (DLT) system, which comprises a first DLT node assigned to the buyer and a second DLT node assigned to the seller, wherein the DLT system is based on a direct data exchange between the DLT nodes of the parties involved and on a direct data validation by the corresponding DLT nodes, wherein the DLT system provides at least one smart contract, comprising program instructions for entering and checking delivery orders and order confirmations,
wherein the method comprises initialising the goods delivery in the DLT system by:
receiving a delivery order of the buyer via a first network by means of the first DLT node relating to goods to be delivered by the seller to the buyer, wherein the delivery order defines one or more physical properties of the goods to be delivered as a first specification, the physical properties of the first specification comprising at least one quantity of goods to be delivered,
creating a first dataset managed by the first DLT node and entering at least the one or more physical properties of the delivery order into the first dataset by means of the first DLT node by using the at least one smart contract, wherein the first dataset is a first part of a dataset shared between the first DLT node and the second DLT node,
transmitting at least the first dataset from the first DLT node to the second DLT node,
creating a second dataset managed by the second DLT node, wherein the second dataset is a second part of the shared dataset, and performing a first update of the second dataset by means of the second DLT node based on the first dataset, wherein the first update comprises entering at least one or more of the physical properties of the first specification into the second dataset, the at least one or more entered physical properties of the first specification comprising the quantity of goods to be delivered,
receiving an order confirmation of the seller via the first network by means of the second DLT node, wherein the order confirmation comprises a second specification of the one or more physical properties of the goods to be delivered,
checking the second specification for compliance with the first specification by using the at least one smart contract,
performing a second update of the second dataset by means of the second DLT node by using a first result of checking the second specification,
transferring at least a first update message from the second DLT node to the first DLT node, and
performing a first update of the first dataset by means of the first DLT node by using the first update message.

2. The method according to claim 1, wherein the at least one smart contract comprises program instructions for entering and checking outgoing goods logs in the course of goods deliveries from the seller to the buyer, and
wherein the method comprises logging of the goods delivery in the DLT system by:
receiving an outgoing goods log from the seller via the first network by means of the second DLT node, wherein the outgoing goods log comprises one or more first sensor values for the one or more physical properties of the outgoing goods according to the second specification, which are detected by means of one or more first physical sensors assigned to the seller, the one or more first sensor values comprising at least one first sensor value which quantifies the delivered quantity of goods,
checking the one or more first sensor values of the outgoing goods log for consistency with the one or more physical properties of the goods to be delivered according to the split dataset within predefined first tolerances by using the at least one smart contract, wherein the checked first sensor values comprise at least the first sensor value quantifying the quantity of goods delivered,
performing a third update of the second dataset by means of the second DLT node by using a second result of checking the one or more first sensor values of the outgoing goods log,
transferring at least one second update message from the second DLT node to the first DLT node, and
performing a second update of the first dataset by means of the first DLT node by using the second update message.

3. The method according to claim 2, wherein the method comprises validating the goods delivery in the DLT system, and
wherein the at least one smart contract comprising program instructions for validating the goods deliveries by:
checking parameters of a validation message for validating the goods delivery by means of the second DLT node by using the at least one smart contract, wherein the parameters comprise at least one quantity of goods to be validated, the parameter checking comprising checking the quantity of goods to be validated for consistency with the first sensor value quantifying the quantity of goods delivered within a predefined second tolerance,
if the quantity of goods to be validated is consistent with the first sensor value quantifying the quantity of goods delivered within the predefined second tolerance, performing a fourth update of the second dataset by means of the second DLT node, wherein the fourth update comprises registering the validation message in the second dataset by means of the second DLT node by using the at least one smart contract,
transferring at least one third update message from the second DLT node to the first DLT node, and
performing a third update of the first dataset by means of the first DLT node by using the third update message, wherein the third update of the first dataset comprises registering the validation message in the first dataset.

4. The method according to claim 3, further comprising signing the data transferred from the first DLT node to the second DLT node by means of the first DLT node, wherein the at least one smart contract on the second DLT node is configured to check the signatures of the transferred data, and
further comprising signing the data transmitted from the second DLT node to the first DLT node by means of the second DLT node, wherein the at least one smart contract on the first DLT node is configured to verify the signatures of the transmitted data,
wherein the data transfer between the first DLT node and the second DLT node is carried out via one or more communication links cryptographically protected using end-to-end encryption, and
wherein establishing the one or more cryptographically protected communication connections comprises a mutual authentication of the first DLT node and the second DLT node in each case.

5. The method according to claim 3, wherein the checking of the second specification for consistency with the first specification in the course of the initialisation is an identity check,
wherein the initialisation further comprises:
if the one or more physical properties according to the second specification that are entered in the second dataset differ from the one or more physical properties according to the first specification from the first dataset, performing a handshake between the first DLT node and the second DLT node to match the first specification of the first dataset and the second specification of the second dataset, so that the first and second specifications resulting from the matching are identical, or
wherein the checking of the second specification for consistency with the first specification during the initialisation is a check for consistency within predefined third tolerances in accordance with the at least one smart contract,
wherein the initialisation further comprises:
if one or more deviations between the one or more physical properties according to the second specification entered in the second dataset and the one or more physical properties according to the first specification from the first dataset are greater than the predefined third tolerances, performing a handshake between the first DLT node and the second DLT node to match the first specification of the first dataset and the second specification of the second dataset so that the first and second specifications resulting from the matching are identical within the predefined fourth tolerances.

6. The method according to claim 3, wherein the program instructions comprised by the at least one smart contract are additionally configured for entering and checking incoming goods logs in the course of goods deliveries from the seller to the buyer, wherein the logging of the goods delivery in the DLT system further comprises:
receiving an incoming goods log from the buyer via the first network by means of the first DLT node, wherein the incoming goods log comprises one or more second sensor values for the one or more physical properties of the incoming goods according to the first specification, which are detected by means of one or more of the second physical sensors assigned to the buyer, wherein the one or more second sensor values comprise at least one second sensor value which quantifies the delivered quantity of goods,
checking the one or more second sensor values of the incoming goods log for compliance with the one or more physical properties of the goods to be delivered according to the split dataset and with the one or more first sensor values according to the outgoing goods log within predefined fourth tolerances by using the at least one smart contract, wherein the second sensor values checked comprise at least the second sensor value quantifying the quantity of goods delivered,
performing a fourth update of the first dataset by means of the first DLT node by using a third result of checking the one or more second sensor values of the incoming goods log,
transferring at least one fourth update message from the first DLT node to the second DLT node, and
performing a fifth update of the second dataset by means of the second DLT node by using the fourth update message.

7. The method according to claim 3, wherein the validation message comprises an invoice and the program instructions comprised by the at least one smart contract are further configured to create the invoice, wherein the invoice creation is carried out by the second DLT node using the at least one smart contract, the validation message parameters being checked in the course of the invoice creation, or
wherein an invoice is received from a first ERP system of the seller that creates the invoice.

8. The method according to claim 3, wherein the data entered in the shared dataset provided in the DLT system in the course of logging the goods delivery is mirrored data of the goods delivery from the first ERP system of the seller and/or a second ERP system of the buyer, wherein the first and/or second ERP system are configured to control the processing of the goods delivery, wherein data consistency between the shared dataset and the ERP systems is ensured by entering the mirrored data, or
wherein the processing of the goods delivery is controlled by the at least one smart contract, the program instructions of which are also configured to control the processing of the goods delivery.

9. The method according to claim 3, wherein the first network is a public network,
wherein a prerequisite for receiving the delivery order of the buyer by means of the first DLT node is a successful authentication of the buyer by the first DLT node, and/or
wherein a prerequisite for receiving the order confirmation of the seller by means of the second DLT node is a successful authentication of the seller by the second DLT node,
wherein a prerequisite for receiving the outgoing goods log from the seller by means of the second DLT node is a successful authentication of the seller by the second DLT node,
wherein a prerequisite for receiving the incoming goods log from the buyer by the first DLT node is a successful authentication of the buyer by the first DLT node,
wherein a prerequisite for the use of the delivery order of the buyer by the first DLT node is a successful signature check of a signature of the delivery order by means of the first DLT node,
wherein a prerequisite for receiving the order confirmation of the seller by means of the second DLT node is a successful signature check of a signature of the order confirmation by the second DLT node,
wherein a prerequisite for the use of the outgoing goods log from the seller by the second DLT node is a successful signature check of a signature of the outgoing goods log by the second DLT node,
wherein a prerequisite for the use of the incoming goods log of the buyer by the first DLT node is a successful signature check of a signature of the incoming goods log by means of the first DLT node,
wherein the first DLT node and the second DLT node are provided by one or more DLT servers of the DLT system,
wherein the one or more DLT servers of the DLT system are arranged in one or more data centres secured against unauthorised access,
wherein the data transfer between the DLT nodes takes place over a second network, and
wherein the second network is a private or a public network.

10. The method according to claim 3, wherein the program instructions comprised by the at least one smart contract are further configured for triggering an electronic payment transaction, wherein the payment transaction by the smart contract is triggered upon the registration of the validation message in the DLT system,
wherein the triggered electronic payment transaction is a bank account transfer from a bank account of the buyer to a bank account of the seller, or
wherein the triggered electronic payment transaction is a transaction of an amount of digital money performed using the DLT system,
wherein the DLT system is configured to transfer the invoice amount to be paid from an account belonging to the buyer for digital money to an account belonging to the seller for digital money, wherein the DLT system is further configured to transform an amount of chiral money of a chiral money account assigned to the buyer into an amount of digital money on the account belonging to the buyer for digital money, and/or
wherein the payment transaction is logged in the DLT system using the at least one smart contract, wherein by using the smart contract electronic account statements relating to the logged payment transaction are also issued for the buyer and/or the seller.

11. A distributed ledger technology (DLT) system for the computer-implemented monitoring of a goods delivery from a seller to a buyer, which comprises a first DLT node assigned to the buyer and a second DLT node assigned to the seller, wherein the first DLT node and the second DLT node are provided by one or more DLT servers of the DLT system, wherein the DLT system provides at least one smart contract, the at least one smart contract comprising program instructions for entering and checking delivery orders, order confirmations and/or outgoing goods logs in the course of goods deliveries from the seller to the buyer and/or for validating the goods deliveries,
wherein the DLT system is configured to:
initialise the goods delivery in the DLT system by:
receiving a delivery order of the buyer via a first network by means of the first DLT node relating to goods to be delivered by the seller to the buyer, wherein the delivery order defines one or more physical properties of the goods to be delivered as a first specification, the physical properties of the first specification comprising at least one quantity of goods to be delivered,
creating a first dataset managed by the first DLT node and entering at least the one or more physical properties of the delivery order into the first dataset by means of the first DLT node by using the at least one smart contract, wherein the first dataset is a first part of a dataset shared between the first DLT node and the second DLT node,
transmitting at least the first dataset from the first DLT node to the second DLT node,
creating a second dataset managed by the second DLT node, wherein the second dataset is a second part of the shared dataset, and performing a first update of the second dataset by means of the second DLT node based on the first dataset, wherein the first update comprises entering at least one or more of the physical properties of the first specification into the second dataset, the at least one or more entered physical properties of the first specification comprising the quantity of goods to be delivered,
receiving an order confirmation of the seller via the first network by means of the second DLT node, wherein the order confirmation comprises a second specification of the one or more physical properties of the goods to be delivered,
checking the second specification for compliance with the first specification by using the at least one smart contract,
performing a second update of the second dataset by means of the second DLT node by using a first result of checking the second specification,
transferring at least a first update message from the second DLT node to the first DLT node, and
performing a first update of the first dataset by means of the first DLT node by using the first update message,
wherein the at least one smart contract comprises program instructions for entering and checking outgoing goods logs in the course of goods deliveries from the seller to the buyer.

12. The DLT system according to claim 11, wherein the DLT system is further configured to:
log the goods delivery in the DLT system by:
receiving an outgoing goods log from the seller via the first network by means of the second DLT node, wherein the outgoing goods log comprises one or more first sensor values for the one or more physical properties of the outgoing goods according to the second specification, which are detected by means of one or more first physical sensors assigned to the seller, the one or more first sensor values comprising at least one first sensor value which quantifies the delivered quantity of goods,
checking the one or more first sensor values of the outgoing goods log for consistency with the one or more physical properties of the goods to be delivered according to the split dataset within predefined first tolerances by using the at least one smart contract, wherein the checked first sensor values comprise at least the first sensor value quantifying the quantity of goods delivered,
performing a third update of the second dataset by means of the second DLT node by using a second result of checking the one or more first sensor values of the outgoing goods log,
transferring at least one second update message from the second DLT node to the first DLT node, and
performing a second update of the first dataset by means of the first DLT node by using the second update message.

13. The DLT system according to claim 12, wherein the DLT system is further configured to:
validate the goods delivery in the DLT system, the at least one smart contract comprising program instructions for validating the goods deliveries by:
checking parameters of a validation message for validating the goods delivery by means of the second DLT node by using the at least one smart contract, wherein the parameters comprise at least one quantity of goods to be validated, the parameter checking comprising checking the quantity of goods to be validated for consistency with the first sensor value quantifying the quantity of goods delivered within a predefined second tolerance,
if the quantity of goods to be validated is consistent with the first sensor value quantifying the quantity of goods delivered within the predefined second tolerance, performing a fourth update of the second dataset by means of the second DLT node, wherein the fourth update comprises registering the validation message in the second dataset by means of the second DLT node by using the at least one smart contract,
transferring at least one third update message from the second DLT node to the first DLT node, and
performing a third update of the first dataset by means of the first DLT node by using the third update message, wherein the third update of the first dataset comprises registering the validation message in the first dataset.

14. A non-transitory computer-readable medium storing instructions for computer-implemented monitoring of a goods delivery from a seller to a buyer using an access-restricted distributed ledger technology (DLT) system, which comprises a first DLT node assigned to the buyer and a second DLT node assigned to the seller, wherein the DLT system is based on a direct data exchange between the DLT nodes of the parties involved and on a direct data validation by the corresponding DLT nodes, wherein the DLT system provides at least one smart contract, comprising program instructions for entering and checking delivery orders and order confirmations, wherein the instructions, when executed by one or more processors of a device, cause the device to:
initialise the goods delivery in the DLT system by:
receiving a delivery order of the buyer via a first network by means of the first DLT node relating to goods to be delivered by the seller to the buyer, wherein the delivery order defines one or more physical properties of the goods to be delivered as a first specification, the physical properties of the first specification comprising at least one quantity of goods to be delivered,
creating a first dataset managed by the first DLT node and entering at least the one or more physical properties of the delivery order into the first dataset by means of the first DLT node by using the at least one smart contract, wherein the first dataset is a first part of a dataset shared between the first DLT node and the second DLT node,
transmitting at least the first dataset from the first DLT node to the second DLT node,
creating a second dataset managed by the second DLT node, wherein the second dataset is a second part of the shared dataset, and performing a first update of the second dataset by means of the second DLT node based on the first dataset, wherein the first update comprises entering at least one or more of the physical properties of the first specification into the second dataset, the at least one or more entered physical properties of the first specification comprising the quantity of goods to be delivered,
receiving an order confirmation of the seller via the first network by means of the second DLT node, wherein the order confirmation comprises a second specification of the one or more physical properties of the goods to be delivered,
checking the second specification for compliance with the first specification by using the at least one smart contract,
performing a second update of the second dataset by means of the second DLT node by using a first result of checking the second specification,
transferring at least a first update message from the second DLT node to the first DLT node, and
performing a first update of the first dataset by means of the first DLT node by using the first update message,
wherein the at least one smart contract comprises program instructions for entering and checking outgoing goods logs in the course of goods deliveries from the seller to the buyer.

15. The non-transitory computer-readable medium according to claim 14, wherein the instructions, when executed by one or more processors of the device, further cause the device to:
log the goods delivery in the DLT system by:
receiving an outgoing goods log from the seller via the first network by means of the second DLT node, wherein the outgoing goods log comprises one or more first sensor values for the one or more physical properties of the outgoing goods according to the second specification, which are detected by means of one or more first physical sensors assigned to the seller, the one or more first sensor values comprising at least one first sensor value which quantifies the delivered quantity of goods,
checking the one or more first sensor values of the outgoing goods log for consistency with the one or more physical properties of the goods to be delivered according to the split dataset within predefined first tolerances by using the at least one smart contract, wherein the checked first sensor values comprise at least the first sensor value quantifying the quantity of goods delivered,
performing a third update of the second dataset by means of the second DLT node by using a second result of checking the one or more first sensor values of the outgoing goods log,
transferring at least one second update message from the second DLT node to the first DLT node, and
performing a second update of the first dataset by means of the first DLT node by using the second update message.

16. The non-transitory computer-readable medium according to claim 15, wherein the instructions, when executed by one or more processors of the device, further cause the device to:
validate the goods delivery in the DLT system, the at least one smart contract comprising program instructions for validating the goods deliveries by:
checking parameters of a validation message for validating the goods delivery by means of the second DLT node by using the at least one smart contract, wherein the parameters comprise at least one quantity of goods to be validated, the parameter checking comprising checking the quantity of goods to be validated for consistency with the first sensor value quantifying the quantity of goods delivered within a predefined second tolerance,
if the quantity of goods to be validated is consistent with the first sensor value quantifying the quantity of goods delivered within the predefined second tolerance, performing a fourth update of the second dataset by means of the second DLT node, wherein the fourth update comprises registering the validation message in the second dataset by means of the second DLT node by using the at least one smart contract,
transferring at least one third update message from the second DLT node to the first DLT node, and
performing a third update of the first dataset by means of the first DLT node by using the third update message, wherein the third update of the first dataset comprises registering the validation message in the first dataset.

17. A method for monitoring of a goods delivery from a seller to a buyer as business partners and executing payments by using an access-restricted distributed ledger technology (DLT) system, which comprises a first DLT node assigned to a first business partner that is the buyer, and a second DLT node assigned to a second business partner that is the seller, wherein at least the first DLT node or the second DLT node is hosted by a respective one of the first or second business partners, and/or at least one of the first or second DLT nodes is hosted by a first bank, wherein the DLT system is based on a direct data exchange between the first DLT node and the second DLT node and on a direct data validation by the corresponding first and second DLT nodes, wherein the DLT system provides at least one smart contract, comprising program instructions for entering and checking delivery orders and order confirmations, the method comprising:
receiving, by the seller by means of the first DLT node, a delivery order relating to goods to be delivered by the seller to the buyer, wherein the delivery order defines a quantity and/or a quality of goods to be delivered as a first specification;
receiving, by the buyer by means of the second DLT node, an order confirmation of the seller, wherein the order confirmation comprises a second specification of the quantity and/or the quality of goods to be delivered;
checking, by the buyer by means of the second DLT node, the second specification for compliance with the first specification by using the at least one smart contract;
receiving, by the buyer by means of the second DLT node, an outgoing goods log from the seller, wherein the outgoing goods log comprises a sensor value for the quantity and/or the quality of goods of the outgoing goods according to the second specification, the sensor value quantifies the quantity and/or defines the quality of goods;
checking, by the buyer by means of the second DLT node, the sensor value of the outgoing goods log for consistency with the quantity and/or the quality of goods to be delivered within predefined first tolerances by using the at least one smart contract;
checking, by the buyer by means of the second DLT node, parameters of a validation message for validating the goods delivery by using the at least one smart contract, wherein the parameters comprise a quantity of goods and/or a quality to be validated, the parameter checking comprising checking the quantity and/or the quality of goods to be validated for consistency with the sensor value quantifying the quantity and/or defining the quality of goods delivered within a predefined second tolerance; and
registering, by the buyer by means of the second DLT node, the validation message by using the at least one smart contract when the quantity of goods and/or the quality to be validated is consistent with the sensor value quantifying the quantity and/or defining the quality of goods delivered within the predefined second tolerance.

18. The method according to claim 17, further comprising:
performing a payment transaction based on the smart contract upon registering the validation message in the DLT system,
wherein the DLT system is configured to transfer an invoice amount to be paid from an account belonging to the buyer for digital money to an account belonging to the seller for digital money, and wherein the DLT system is configured to transfer the invoice amount to be paid from an eWallet belonging to the buyer to an eWallet belonging to the seller, wherein the payment transaction is logged in the DLT system using the at least one smart contract, wherein, by using the smart contract electronic account, statements relating to the logged payment transaction are issued by seller node and buyer node for the buyer and/or the seller.

19. The method according to claim 18, further comprising:
transforming an amount of bank money of a bank account assigned to the buyer into an amount of digital money on the eWallet belonging to the buyer, or
transforming an amount of fiat money of a bank account assigned to the seller into an amount of digital money on the eWallet belonging to the seller.

20. The method according to claim 19, wherein a status of the eWallet of the buyer is evaluated regarding solvency prior to a payment transaction to the seller by the DLT node of the buyer and/or a bank DLT node associated with the bank, a banking system or a bank computer system, and wherein in case of non-solvency with regard to the intended payment transaction, the bank is requested by the second node of the DLT node of the seller to establish sufficient funding, and wherein the bank issues a value date at least up to solvency for the intended payment transaction.

21. The method according to claim 20, wherein the bank performs a verification prior to issuing the value date by the smart contract of the buyer if the automated establishment of solvency for the intended payment transaction is admissible.

22. The method according to claim 17, wherein at least one of the seller or the buyer hosts a node for the smart contract.

23. The method according to claim 17, wherein a second finance partner hosts a part of the first DLT node and the second DLT node.
